(19) United States
(12) Patent Application Publication
(10) Pub. No.: US 2024/0056203 A1
(43) Pub. Date: Feb. 15, 2024

(54) METHOD AND APPARATUS FOR ENERGY SAVING IN WIRELESS COMMUNICATION SYSTEM

(71) Applicant: Samsung Electronics Co., Ltd., Gyeonggi-do (KR)

(72) Inventors: Junyung YI, Gyeonggi-do (KR); Youngbum KIM, Gyeonggi-do (KR); Seongmok LIM, Gyeonggi-do (KR); Youngrok JANG, Gyeonggi-do (KR); Kyoungmin PARK, Gyeonggi-do (KR)

(21) Appl. No.: 18/366,246

(22) Filed: Aug. 7, 2023

(30) Foreign Application Priority Data
Aug. 5, 2022 (KR) 10-2022-0098060

(51) Int. Cl. H04B 17/318; H04L 5/00

(52) U.S. Cl. CPC H04B 17/328; H04L 5/0051

(57) ABSTRACT

The disclosure relates to a 5G or 6G communication system for supporting a higher data transmission rate. A method performed by a user equipment (UE) in a wireless communication system includes receiving, from a base station, configuration information associated with at least one first reference signal (RS), receiving, from the base station, reconfiguration information associated with at least one second RS, and identifying a pathloss-RS (PL-RS) for measuring a downlink pathloss based on the configuration information and the reconfiguration information, wherein a first transmission density of the at least one first RS is greater than a second transmission density of the at least one second RS.

### CROSS-REFERENCE TO RELATED APPLICATION(S)

This application is based on and claims priority under 35 U.S.C. § 119 to Korean Patent Application No. 10-2022-0098060, which was filed in the Korean Intellectual Property Office on Aug. 5, 2022, the disclosure of which is incorporated herein by reference in its entirety.

### BACKGROUND

### 1. Field

The disclosure relates generally to a wireless communication system, and more particularly, to a method and an apparatus for energy saving in a wireless communication system.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR—U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

As the wireless communication system has advanced to provide various services, a method for smoothly providing the services is needed in the art. Particularly, there is a need in the art for a technology for controlling a reference signal to reduce the energy consumption of a base station in a wireless communication system.

### SUMMARY

The disclosure has been made to address at least the above-mentioned problems and/or disadvantages and to provide at least the advantages described below.

Accordingly, an aspect of the disclosure is to provide an apparatus and a method capable of effectively providing a service in a wireless communication system.

Another aspect of the disclosure is to provide an operation of a BS and a terminal determining a reference signal for measuring downlink path loss during an operation for reducing energy consumption of a BS.

Another aspect of the disclosure is to provide a BS that may determine a reference signal for measuring downlink path loss to reduce energy consumption and perform channel state and beam management.

In accordance with an aspect of the disclosure, a method performed by a user equipment (UE) in a wireless communication system includes receiving, from a base station, configuration information associated with at least one first reference signal (RS), receiving, from the base station, reconfiguration information associated with at least one second RS; and identifying a pathloss-RS (PL-RS) for measuring a downlink pathloss based on the configuration information and the reconfiguration information, wherein a first transmission density of the at least one first RS is greater than a second transmission density of the at least one second RS.

In accordance with an aspect of the disclosure, a method performed by a base station in a wireless communication system includes transmitting, to a UE, configuration information associated with at least one first RS, and transmitting, to the UE, reconfiguration information associated with at least one second RS, wherein a PL-RS for measuring a downlink pathloss is identified based on the configuration information and the reconfiguration information, and wherein a first transmission density of the at least one first RS is greater than a second transmission density of the at least one second RS.

In accordance with an aspect of the disclosure, a UE includes a transceiver, and at least one processor coupled with the transceiver and configured to receive, from a base station, configuration information associated with at least one first RS, receive, from the base station, reconfiguration information associated with at least one second RS, and identify a PL-RS for measuring a downlink pathloss based on the configuration information and the reconfiguration information, wherein a first transmission density of the at least one first RS is greater than a second transmission density of the at least one second RS.

In accordance with an aspect of the disclosure, a base station in a wireless communication system includes a transceiver, and at least one processor coupled with the transceiver and configured to transmit, to a UE, configuration information associated with at least one first RS, and transmit, to the UE, reconfiguration information associated with at least one second RS, wherein a PL-RS for measuring a downlink pathloss is identified based on the configuration information and the reconfiguration information, and wherein a first transmission density of the at least one first RS is greater than a second transmission density of the at least one second RS.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a basic structure of a time-frequency domain that is a wireless resource region in a wireless communication system according to an embodiment of the disclosure;

FIG. 2 illustrates a slot structure considered in a wireless communication system according to an embodiment of the disclosure;

FIG. 3 illustrates an embodiment of a time domain mapping structure of a synchronization signal and a beam sweeping operation according to the disclosure;

FIG. 4 illustrates a synchronization signal block (SSB) considered in a wireless communication system according to an embodiment of the disclosure;

FIG. 5 illustrates various transmission cases of an SSB in a frequency band lower than 6 GHz considered in a communication system according to an embodiment of the disclosure;

FIG. 6 illustrates transmission cases of an SSB in a frequency band of 6 GHz or higher considered in a wireless communication system according to an embodiment of the disclosure;

FIG. 7 illustrates transmission cases of an SSB according to a subcarrier spacing in a time of 5 milliseconds (ms) in a wireless communication system according to an embodiment of the disclosure;

FIG. 8 illustrates a demodulation reference signal (DMRS) pattern used in communication between a base station and a terminal in a 5G system according to an embodiment of the disclosure;

FIG. 9 illustrates channel estimation using a DMRS received in one physical UL shared channel (PUSCH) in a time band of a 5G system according to an embodiment of the disclosure;

FIG. 10 illustrates a method of reconfiguring SSB transmission through dynamic signaling of a 5G system according to an embodiment of the disclosure;

FIG. 11 is a flowchart for a terminal that determines an RS resource for a pathloss-reference signal (PL-RS) according to reconfiguration of a reference signal for energy saving of a 5G system according to an embodiment of the disclosure;

FIG. 12 is a flowchart of an operation of reconfiguring a reference signal for energy saving of a 5G system according to an embodiment of the disclosure;

FIG. 13 illustrates a terminal according to an embodiment; and

FIG. 14 illustrates a base station according to an embodiment.

### DETAILED DESCRIPTION

Hereinafter, embodiments of the disclosure are described in detail with reference to the accompanying drawings.

In describing the embodiments, technical contents well known in the technical field to which the disclosure pertains and which are not directly related to the disclosure will be omitted for the sake of clarity and conciseness.

For the same reason, some components in the accompanying drawings are exaggerated, omitted, or schematically illustrated, and a size of each component does not entirely reflect an actual size. The same reference number is given to the same or corresponding element in each drawing.

Advantages and features of the disclosure, and methods for achieving them will be clarified with reference to embodiments described below in detail together with the accompanying drawings. However, the disclosure is not limited to the embodiments disclosed below but may be implemented in various different forms, the embodiments are provided to only complete the scope of the disclosure and to allow those skilled in the art to which the disclosure pertains to fully understand a category of the disclosure. The same reference numeral refers to the same element throughout the specification.

The components included in the disclosure are expressed in a singular or plural form. However, the singular or plural expression is appropriately selected according to a particular situation for the convenience of explanation, the disclosure is not limited to a single component or a plurality of components, the components expressed in the plural form may be configured as a single component, and the components expressed in the singular form may be configured as a plurality of components.

The term unit or the terms including the suffixes -or, -er, or the like used hereinafter may indicate a unit of processing at least one function or operation, and may be embodied by hardware, software, or a combination of hardware and software.

In the following description, a base station (BS) is an entity that allocates resources to terminals, and may be at least one of a gNode B, an eNode B, a Node B, a wireless access unit, a base station controller, and a node on a network. A terminal may include a user equipment (UE), a mobile station (MS), a cellular phone, a smartphone, a computer, or a multimedia system capable of performing communication functions. A “DL (DL)” refers to a radio link by which a BS transmits a signal to a terminal, and an “UL (UL)” refers to a radio link by which a terminal transmits a signal to a BS. LTE or LTE-A systems may be described herein by way of example, but the embodiments of the disclosure may also be applied to other communication systems having similar technical backgrounds or channel types, such as 5th generation mobile communication technologies (5G, new radio, and NR) developed beyond LTE-A. 5G herein may be the concept that covers the exiting LTE, LTE-A, or other similar services. Embodiments of the disclosure may also be applied to other communication systems through some modifications without significantly departing from the scope of the disclosure.

As used herein, a “unit” refers to a software element or a hardware element, such as a field programmable gate array (FPGA) or an application specific integrated circuit (ASIC), which performs a predetermined function. However, the unit does not always have a meaning limited to software or hardware and may be constructed either to be stored in an addressable storage medium or to execute one or more processors. Therefore, the unit includes software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the unit may be either combined into fewer elements, or a unit, or divided into more elements, or a unit. Moreover, the elements and units may be implemented to reproduce one or more central processing units (CPUs) within a device or a security multimedia card. The unit in the embodiments may include one or more processors.

Hereinafter, a method and an apparatus ae disclosed for improving UL coverage when a random access procedure is performed, but are not applied limitedly to each example. It may be possible to use all one or more embodiments proposed in the disclosure, or a combination of some embodiments in a frequency resource configuration method corresponding to a different channel. Therefore, embodiments of the disclosure may be applied through partial modification without departing from the scope of the disclosure through determination by a person skilled in the art.

The terms which will be described below are defined in consideration of the functions in the disclosure, and may be different according to users, intentions of the users, or customs. Therefore, the definitions of the terms should be made based on the contents throughout the specification.

The above-described three services in the 5G communication system (hereinafter, may be interchangeably used with “5G system”), that is, eMBB, URLLC, and mMTC, may be multiplexed and transmitted in a single system. In order to satisfy different requirements of the respective services, different transmission/reception techniques and transmission/reception parameters may be used between the services. However, the above mMTC, URLLC and eMBB are merely examples of different types of services, and service types according to an embodiment of the disclosure are not limited to the above examples.

Hereinafter, a frame structure of a 5G system will be described in detail with reference to the drawings. A wireless communication system according to an embodiment of the disclosure will be described with a configuration of a 5G system as an example for convenience of explanation, but embodiments of the disclosure may also be applied to a 5G or beyond system or a different communication system to which the disclosure is applicable.

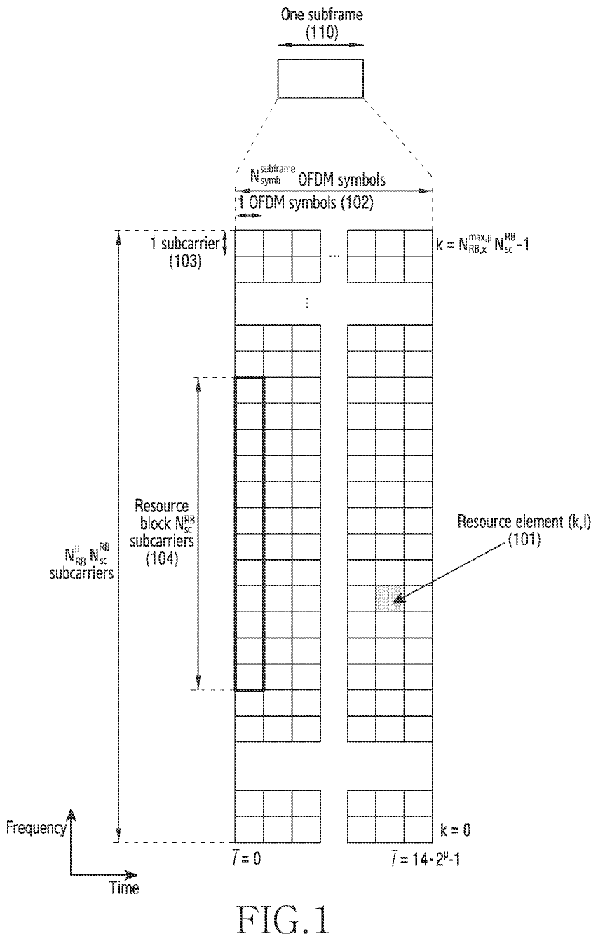

FIG. 1 illustrates a basic structure of a time-frequency domain that is a wireless resource region in a wireless communication system according to an embodiment of the disclosure.

Referring to FIG. 1, the transverse axis indicates a time domain, and the longitudinal axis indicates a frequency domain. A basic unit of resources in the time-frequency domain is a resource element (RE) 101, and may be defined by one orthogonal frequency division multiplexing (OFDM) symbol 102 (or a discrete Fourier transform spread OFDM (DFT-s-OFDM) symbol) in the time domain and one subcarrier 103 in the frequency domain. In the frequency domain, a N_{sc}^{RB} number (e.g., 12) of consecutive REs, which indicates the number of subcarriers per resource block (RB), may configure one resource block (RB) 104. In the time domain, a N_{symb}^{subframe} number of consecutive OFDM symbols, which indicates the number of symbols per subframe, may configure one subframe 110.

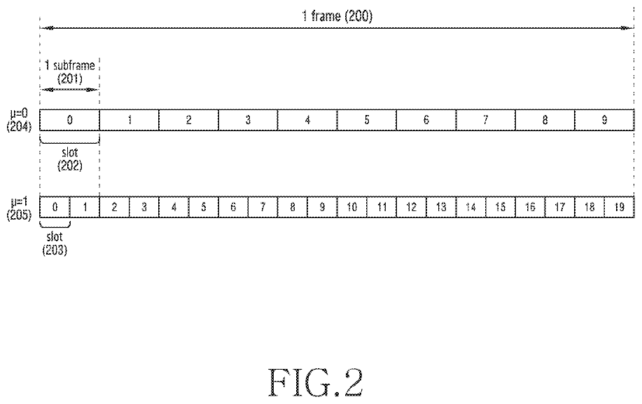

FIG. 2 illustrates a slot structure considered in a wireless communication system according to an embodiment of the disclosure.

Referring to FIG. 2, an example of a slot structure including a frame 200, a subframe 201, and a slot 202 or 203 is illustrated. The one frame 200 may be defined as 10 ms. The one subframe 201 may be defined as 1 ms, and thus the one frame 200 may be configured by a total of 10 subframes 201. The one slot 202 or 203 may be defined as 14 OFDM symbols (i.e., the number (N_{synb}^{slot}) of symbols per one slot=14). The one subframe 201 may be configured by one or multiple slots 202 or 203, and the number of slots 202 or 203 per one subframe 201 may vary according to a configuration value μ 204 or 205 of subcarrier spacing (SCS).

Slot structures of μ=0 204 and μ=1 205 as a subcarrier spacing configuration value are illustrated. When μ=0 204, the one subframe 201 may be configured by the one slot 202, and when μ=1 205, the one subframe 201 may be configured by two slots (e.g., including the slots 203). That is, the number (Nₛₗₒₜ^{subframe,μ}) of slots per one subframe may vary according to a configuration value p of a subcarrier spacing, and the number (Nₛₗₒₜ^{frame,μ}) of slots per one frame may vary accordingly. For example, Nₛₗₒₜ^{subframe,μ} and Nₛₗₒₜ^{subframe,μ} according to each subcarrier spacing configuration μ may be defined by Table 1 below.

TABLE 1

| μ | N_{symb}^{slot} | Nₛₗₒₜ^{frame,μ} | Nₛₗₒₜ^{subframe,μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |
| 6 | 14 | 640 | 64 |

In a 5G communication system, a BS may transmit a synchronization signal block (SSB) (or SS block or SS/PBCH block) to a terminal for initial access of the terminal, and the SSB may include a primary synchronization signal (PSS), a secondary synchronization signal (SSS), and a physical broadcast channel (PBCH).

In an initial access stage at which the terminal accesses a system, the terminal may first perform cell search to obtain DL time/frequency domain synchronization and a cell identification (ID) from a synchronization signal. The synchronization signal may include a PSS and an SSS. The terminal may receive a PBCH transmitting a master information block (MIB) from the BS to obtain a basic parameter value and system information related to transmission and/or reception, such as a system bandwidth or relevant control information. Based on the basic parameter value and system information related to transmission and/or reception, the terminal may decode a control channel (e.g., a physical DL control channel (PDCCH)) and a data channel (e.g., a physical DL shared channel (PDSCH)) to obtain a system information block (SIB). Hereinafter, a control channel may denote a PDCCH or a physical UL control channel (PUCCH), a PDCCH may be referred to as a DL control channel, and a PUCCH may be referred to as an UL control channel. In addition, a data channel may denote a PDSCH or a physical UL shared channel (PUSCH), a PDSCH may be referred to as a DL data channel, and a PUSCH may be referred to as an UL data channel. After obtaining the SIB, the terminal may exchange identification-related information (e.g., cell ID) of the terminal with the BS through a random access stage, and may initially access a network through registration and authentication stages. In addition, the terminal may receive an SIB from the BS to obtain cell-common control information related to transmission and/or reception. For example, the cell-common control information related to transmission and/or reception may include at least one of random access-related control information, paging-related control information, and common control information about various physical channels (e.g., PDCCH and PUCCH).

A synchronization signal serves as a criterion of cell search, and a subcarrier spacing suitable for a channel environment (e.g., phase noise of each frequency band) may be applied thereto. In a data channel (e.g., PDSCH or PUSCH) or a control channel (e.g., PDCCH or PUCCH), different subcarrier spacings may be applied to support various services required in a 5G communication system according to service types.

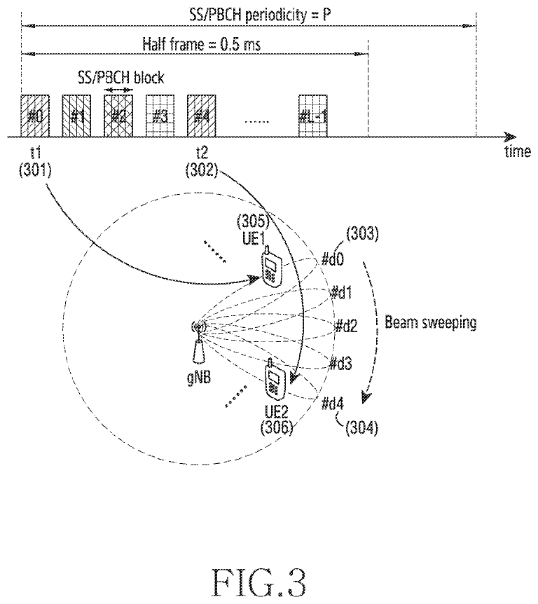

FIG. 3 illustrates a time domain mapping structure of a synchronization signal and a beam sweeping operation according to an embodiment of the disclosure.

For description, the following elements may be defied.

A PSS serves as a criterion of DL time/frequency synchronization, and may provide partial information of a cell ID.

An SSS serves as a criterion of DL time/frequency synchronization, and may provide information of a cell ID except for a PSS. Additionally, this signal may serve as a reference signal for demodulation of a PBCH.

The PBCH may provide necessary system information (e.g., MIB) required for transmitting and/or receiving a data channel and a control channel by a terminal. For example, the necessary system information may include at least one of search space-related control information including wireless resource mapping information of a control channel, scheduling control information for a separate data channel transmitting system information, and a system frame number (SFN) that is a frame unit index serving as a timing criterion.

An SS/PBCH block may be configured by N (e.g., N is 4 in a 5G system) OFDM symbols, and may include a PSS, an SSS, and a PBCH. In a system to which a beam sweeping technique is applied, an SS/PBCH block may be a minimum unit to which beam sweeping is applied. A BS may transmit a maximum L number (e.g., #0 to #L−1) of SS/PBCH blocks to a terminal, and L SS/PBCH blocks may be transmitted (or mapped) in a half frame (0.5 ms). L SS/PBCH blocks may be repeated according to the unit of a predetermined period P. A BS may notify a terminal of period P through particular signaling (e.g., radio resource control (RRC) message). If there is no separate signaling relating to period P from the BS, the terminal may apply a pre-promised (or configured) default value.

In FIG. 3, beam sweeping is applied in a unit of an SS/PBCH block overtime. A terminal may obtain an optimal synchronization signal through a beam radiated from a BS toward the terminal. For example, a first terminal (UE1) 305 may receive an SS/PBCH block by using a beam radiated in a direction of #d0 303 through beamforming applied to SS/PBCH block #0 at t1 301. A second terminal (UE2) 306 may receive an SS/PBCH block by using a beam radiated in a direction of #d4 304 through beamforming applied to SS/PBCH block #4 at t2 302. Therefore, the first terminal 305 may have difficulty in obtaining synchronization information and/or necessary system information from an SS/PBCH block transmitted through a beam radiated in the #d4 direction that is away from the location of the first terminal. In this case, the beam radiated in the #d4 direction is radiated in a different direction from a beam that can be received by the first terminal, which may mean a beam that is difficult to be received by the first terminal.

Even in a procedure other than the initial access procedure, a terminal may receive an SS/PBCH block to determine whether the radio link quality of the current cell is maintained at a predetermined level or higher. In addition, a terminal may determine the radio link quality of a neighboring cell in a handover (or handoff) procedure for the terminal to move from the current cell (or serving cell) to the neighboring cell (or target cell), and may receive an SS/PBCH block of the neighboring cell to obtain time/frequency synchronization with the neighboring cell.

Hereinafter, an initial cell access operation procedure of a 5G communication system will be described.

A synchronization serves as a criterion of cell search, and a subcarrier spacing suitable for a channel environment (e.g., phase noise) of each frequency band is applied to a synchronization signal to be transmitted. A BS (e.g., gNB) may transmit multiple SSBs to a terminal according to the number of analog beams that the BS is to operate. For example, a PSS and an SSS may be mapped and transmitted in 12 RBs, and a PBCH may be mapped and transmitted in 24 RBs. Hereinafter, a structure in which a synchronization signal and a PBCH are transmitted in a 5G system will be described.

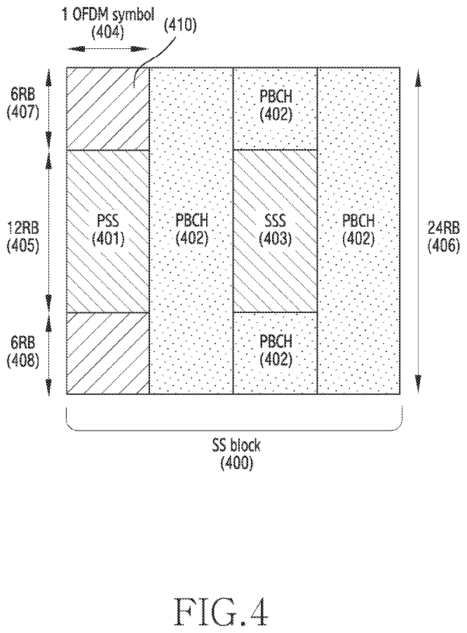

FIG. 4 illustrates an SSB considered in a wireless communication system according to an embodiment of the disclosure.

Referring to FIG. 4, an SSB 400 may include a PSS 401, an SSS 403, and a PBCH 402.

The SSB 400 may be mapped to four OFDM symbols 404 in the time domain. The PSS 401 and the SSS 403 may have a length of 12 RBs 405 in the frequency domain and may be transmitted in the first and third OFDM symbols in the time domain, respectively. For example, in a 5G system, a total of 1008 different cell IDs may be defined. According to the physical cell ID (PCI) of a cell, the PSS 401 may have three different values, and the SSS 403 may have 336 different values. A terminal may obtain one of cell IDs of 1008 (336×3) combinations through detection of the PSS 401 and the SSS 403. A method of obtaining one of cell IDs of 1008 combinations by a terminal may be expressed by Equation (1) below.

N_{ID}^{cell}=3N_{ID}⁽¹⁾+N_{ID}⁽²⁾ (1)

In Equation (1), N_{ID}⁽¹⁾ may be estimated from the SSS 403, and may have one value among 0 to 335, and N_{ID}⁽²⁾ may be estimated from the PSS 401 and may have one value among 0 to 2. A terminal may estimate a N_{ID}^{(cell)} value that is a cell ID through a combination of N_{ID}⁽¹⁾ and N_{ID}⁽²⁾.

The PBCH 402 may have a length of 24 RBs 406 in the frequency domain and may be transmitted in the two to fourth OFDM symbols of the SS block in the time domain. The PBCH 402 may have a length of 12 RBs 407 and 408 remaining by excluding, from the third OFDM block, 12 RBs 405 in which the SSS 403 is transmitted. The PBCH 402 may include a PBCH payload and/or a PBCH demodulation reference signal (DMRS), and the PBCH payload may include various system information (e.g., MIB). For example, an MIB may include pieces of information as shown below in Table 2.

TABLE 2

| | |
|---|---|
| MIB::= | SEQUENCE { |
| systemFrameNumber | BIT STRING (SIZE (6)), |
| subCarrierSpacingCommon | ENUMERATED (scs 15or60, |
| ssb-SubcarrierOffset | scs30or120), |
| dmrs-TypeA-Position | INTEGER (0..15), |
| pdcch-ConfigSIB1 | ENUMERATED {pos2, pos3}, |
| cellBarred | PDCCH-ConfigSIB1, |
| intraFreqReselection | ENUMERATED {barred, notBarred}, |
| spare | ENUMERATED {allowed, |
| } | notAllowed}, |
| | BIT STRING (SIZE (1)) |

As to SSB information, the offset of an SSB in the frequency domain may be indicated by ssb-SubcarrierOffset that is four bits in an MIB. A terminal may indirectly obtain the index of an SSB including a PBCH through decoding a PBCH DMRS and the PBCH. In an embodiment, in a frequency band lower than 6 GHz, three bits obtained through decoding of a PBCH DMRS may indicate an SSB index, and in a frequency band of 6 GHz or higher, three bits obtained through decoding of a PBCH DMRS and three bits included in a PBCH payload and obtained through PBCH decoding may indicate the index of an SSB including the PBCH.

As to PDCCH configuration information, a subcarrier spacing of a common DL control channel may be indicated through one bit (subCarrierSpacingCommon) in an MIB, and time-frequency resource information of a control resource set (CORESET) and a search space may be indicated through eight bits (pdcch-ConfigSIB1).

An SFN may be indicated through six bits in an MIB. A least significant bit (LSB) of an SFN may have a size of four bits, and the LSB may be included in a PBCH payload. Therefore, a terminal may indirectly obtain an LSB through PBCH decoding.

Timing-in-radio frame information may be included in an SSB index and a PBCH payload described above, may be obtained through PBCH decoding, and may have a size of one bit. A terminal may indirectly identify whether an SSB has been transmitted in the first or second half frame of a radio frame, through timing-in-radio frame information.

The transmission bandwidth (12 RBs 405) of the PSS 401 and the SSS 403 and the transmission bandwidth (24 RBs 406) of the PBCH 402 are different from each other. Therefore, 12 RBs 407 and 408 remaining by excluding 12 RBs 405 in which the PSS 401 is transmitted may exist in the first OFDM symbol in which the PSS 401 is transmitted in the transmission bandwidth of the PBCH 402. In the first OFDM symbol, the area of 12 RBs 407 and 408 remaining by excluding 12 RBs 405 in which the PSS 401 is transmitted may be used to transmit a different signal, or may be empty.

SSBs may be transmitted using the same analog beam. For example, the PSS 401, the SSS 403, and the PBCH 402 may all be transmitted using the same analog beam. Analog beams are unable to be applied differently in the frequency domain, and thus the same analog beam may be applied in all RBs in the frequency domain in a particular OFDM symbol to which a particular analog beam is applied. For example, four OFDM symbols in which the PSS 401, the SSS 403, and the PBCH 402 are transmitted may all be transmitted using the same analog beam.

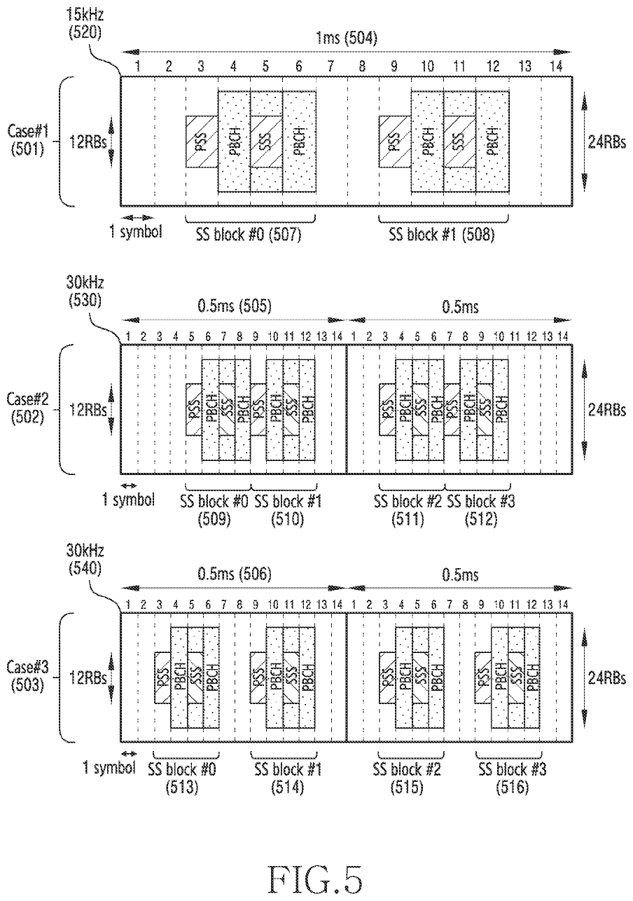

FIG. 5 illustrates various transmission cases of an SSB in a frequency band lower than 6 GHz considered in a communication system according to an embodiment of the disclosure.

Referring to FIG. 5, in a frequency band of 6 GHz or lower in a 5G communication system, a subcarrier spacing 520 of 15 kHz and a subcarrier spacing 530 or 540 of 30 kHz may be used for SSB transmission. In relation to the subcarrier spacing 520 of 15 kHz, case #1 501 relating to an SSB may exist, and in relation to the subcarrier spacing 530 or 540 of 30 kHz, two transmission cases (e.g., case #2 502 and case #3 503) relating to an SSB may exist.

In case #1 501 of the subcarrier spacing of 15 kHz 520, a maximum of two SSBs may be transmitted within a time of 1 ms 504, which corresponds to one slot length when one slot is configured by 14 OFDM symbols. In case #1 501, SSB #0 507 and SSB #1 508 are illustrated. For example, SSB #0 507 may be mapped to four consecutive symbols from the third OFDM symbol, and SSB #1 508 may be mapped to four consecutive symbols from the ninth OFDM symbols.

Different analog beams may be applied to SSB #0 507 and SSB #1 508. However, the same analog beam may be applied to the third to sixth OFDM symbols to which SSB #0 507 is mapped. In addition, the same analog beam may be applied to the ninth to twelfth OFDM symbols to which SSB #1 508 is mapped. A BS may determine which analog beam is to be used in the seventh, eighth, thirteenth, and fourteenth OFDM symbols to which an SSB is not mapped.

In case #2 502 of the subcarrier spacing of 30 kHz 530, a maximum of two SSBs may be transmitted within a time of 0.5 ms 505, which corresponds to one slot length when one slot is configured by 14 OFDM symbols. Therefore, a maximum of four SSBs may be transmitted within a time of 1 ms, which corresponds to two-slot length when one slot is configured by 14 OFDM symbols. For example, case #2 502 may indicate SSB #0 509, SSB #1 510, SSB #2 511, and SSB #3 512 being transmitted in a time of 1 ms (e.g., two slots). SSB #0 509 may be mapped from the fifth OFDM symbol of the first slot, and SSB #1 510 may be mapped from the ninth OFDM symbol of the first slot. SSB #2 511 may be mapped from the third OFDM symbol of the second slot, and SSB #3 512 may be mapped from the seventh OFDM symbol of the second slot.

Different analog beams may be applied to SSB #0 509, SSB #1 510, SSB #2 511, and SSB #3 512. However, the same analog beam may be applied to the fifth to eighth OFDM symbols of the first slot in which SSB #0 509 is transmitted, and the same analog beam may be applied to the ninth to twelfth OFDM symbols of the first slot in which SSB #1 510 is transmitted. In addition, the same analog beam may be applied to the third to sixth symbols of the second slot in which SSB #2 511 is transmitted, and the same analog beam may be applied to the seventh to tenth symbols of the second slot in which SSB #3 512 is transmitted. A BS may determine which analog beam is to be used in OFDM symbols to which an SSB is not mapped.

In case #3 503 of the subcarrier spacing of 30 kHz 540, a maximum of two SSBs may be transmitted within a time of 0.5 ms 506, which corresponds to one slot length when one slot is configured by 14 OFDM symbols. Therefore, a maximum of four SSBs may be transmitted within a time of 1 ms, which corresponds to two-slot length when one slot is configured by 14 OFDM symbols. For example, case #3 503 may indicate SSB #0 513, SSB #1 514, SSB #2 515, and SSB #3 516 being transmitted in a time of 1 ms (i.e., two slots). SSB #0 513 may be mapped from the third OFDM symbol of the first slot, SSB #1 514 may be mapped from the ninth OFDM symbol of the first slot, SSB #2 515 may be mapped from the third OFDM symbol of the second slot, and SSB #3 516 may be mapped from the ninth OFDM symbol of the second slot.

Different analog beams may be used for SSB #0 513, SSB #1 514, SSB #2 515, and SSB #3 516. However, the same analog beam may be applied to the third to sixth OFDM symbols of the first slot in which SSB #0 513 is transmitted, and the same analog beam may be applied to the ninth to twelfth OFDM symbols of the first slot in which SSB #1 514 is transmitted. In addition, the same analog beam may be applied to the third to sixth symbols of the second slot in which SSB #2 515 is transmitted, and the same analog beam may be applied to the ninth to twelfth symbols of the second slot in which SSB #3 516 is transmitted. A BS may determine which analog beam is to be used in OFDM symbols to which an SSB is not mapped.

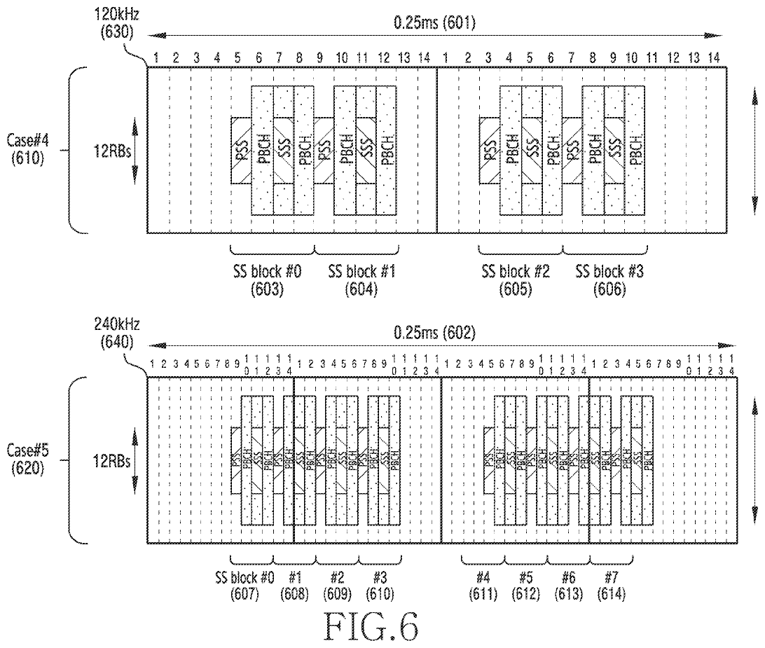

FIG. 6 illustrates transmission cases of an SSB in a frequency band of 6 GHz or higher considered in a wireless communication system according to an embodiment of the disclosure.

Referring to FIG. 6, in a frequency band of 6 GHz or higher in a 5G system, a subcarrier spacing of 120 kilohertz (kHz) 630 in case #4 610 and a subcarrier spacing of 240 kHz 640 in case #5 620 may be used for SSB transmission.

In case #4 610 of the subcarrier spacing of 120 kHz 630, a maximum of four SSBs may be transmitted within a time of 0.25 ms 601, which corresponds to two-slot length when one slot is configured by 14 OFDM symbols. Case #4 610 may indicate SSB #0 603, SSB #1 604, SSB #2 605, and SSB #3 606 being transmitted in a time of 0.25 ms (e.g., two slots). SSB #0 603 may be mapped to four consecutive symbols from the fifth OFDM symbol of the first slot, and SSB #1 604 may be mapped to four consecutive symbols from the ninth OFDM symbol of the first slot. In addition, SSB #2 605 may be mapped to four consecutive symbols from the third OFDM symbol of the second slot, and SSB #3 606 may be mapped to four consecutive symbols from the seventh OFDM symbol of the second slot.

Different analog beams may be used for SSB #0 603, SSB #1 604, SSB #2 605, and SSB #3 606. However, the same analog beam may be used in the four OFDM symbols in which each SSB is transmitted. A BS may determine which beam is to be used in OFDM symbols to which an SSB is not mapped.

In case #5 620 of the subcarrier spacing of 240 kHz 640, a maximum of eight SSBs may be transmitted within a time of 0.25 ms 602, which corresponds to four-slot length when one slot is configured by 14 OFDM symbols. This case may indicate SSB #0 607, SSB #1 608, SSB #2 609, SSB #3 610, SSB #4 611, SSB #5 612, SSB #6 613, and SSB #7 614 being transmitted in a time of 0.25 ms (e.g., four slots).

SSB #0 607 may be mapped to four consecutive symbols from the ninth OFDM symbol of the first slot, and SSB #1 608 may be mapped to four consecutive symbols from the thirteenth OFDM symbol of the first slot. SSB #2 609 may be mapped to four consecutive symbols from the third OFDM symbol of the second slot, and SSB #3 610 may be mapped to four consecutive symbols from the seventh OFDM symbol of the second slot. SSB #4 611 may be mapped to four consecutive symbols from the fifth OFDM symbol of the third slot, SSB #5 612 may be mapped to four consecutive symbols from the ninth OFDM symbol of the third slot, and SSB #6 613 may be mapped to four consecutive symbols from the thirteenth OFDM symbol of the third slot. SSB #7 614 may be mapped to four consecutive symbols from the third OFDM symbol of the fourth slot.

Different analog beams may be used for SSB #0 607, SSB #1 608, SSB #2 609, SSB #3 610, SSB #4 611, SSB #5 612, SSB #6 613, and SSB #7 614, respectively. The same analog beam may be used in the four OFDM symbols in which each SSB is transmitted. A BS may determine which analog beam is to be used in OFDM symbols to which an SSB is not mapped.

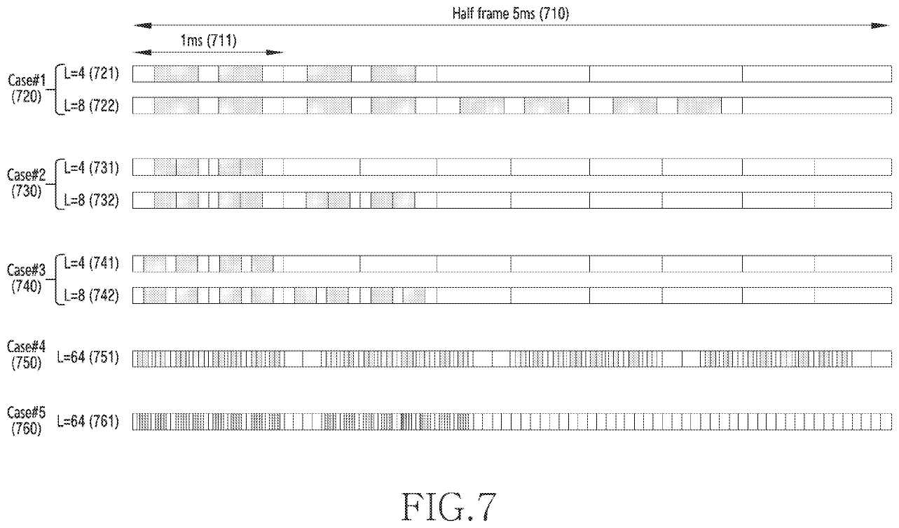

FIG. 7 illustrates transmission cases of an SSB according to a subcarrier spacing in a time of 5 ms in a wireless communication system according to an embodiment of the disclosure.

Referring to FIG. 7, in a 5G system, an SSB may be periodically transmitted in a unit of a time interval 710 (this corresponds to five subframes or one half frame) of 5 ms.

In a frequency band of 3 GHz or lower, a maximum of four SSBs may be transmitted within a time of 5 ms 710. In a frequency band from 3 GHz (exclusive) to 6 GHz (inclusive), a maximum of eight SSBs may be transmitted. In a frequency band exceeding 6 GHz, a maximum of 64 SSBs may be transmitted. Subcarrier spacings of 15 kHz and 30 kHz may be used at a frequency of 6 GHz or lower.

In case #1 501 at a subcarrier spacing of 15 kHz at which one slot is configured, described with reference to FIG. 5, an SSB in a frequency band of 3 GHz or lower may be mapped to the first slot and the second slot, and thus a maximum length (L) of four SSBs 721 may be transmitted. An SSB in a frequency band from 3 GHz (exclusive) to 6 GHz (inclusive) may be mapped to the first slot, the second slot, the third slot, and the fourth slot, and thus a maximum of eight SSBs 722 may be transmitted. In case #2 502 or case #3 503 at a subcarrier spacing of 30 kHz at which two slots are configured, described with reference to FIG. 5, an SSB in a frequency band of 3 GHz or lower may be mapped from the first slot, and thus a maximum of four SSBs 731 or 741 may be transmitted. An SSB in a frequency band from 3 GHz (exclusive) to 6 GHz (inclusive) may be mapped starting from the first slot and the third slot, and thus a maximum of eight SSBs 732 or 742 may be transmitted.

Subcarrier spacings of 120 kHz and 240 kHz may be used at a frequency exceeding 6 GHz. In case #4 610 at a subcarrier spacing of 120 kHz at which two slots are configured, described with reference to FIG. 6, an SSB in a frequency band exceeding 6 GHz may be mapped starting from 1st, 3rd, 5th, 7th, 11th, 13th, 15th, 17th, 21st, 23rd, 25th, 27th, 31st, 33rd, 35th, and 37th slots, and thus a maximum of 64 SSBs 751 may be transmitted. In case #5 620 at a subcarrier spacing of 240 kHz at which four slots are configured, described with reference to FIG. 6, an SSB in a frequency band exceeding 6 GHz may be mapped from 1st, 5th, 9th, 13th, 21st, 25th, 29th, and 33rd slots, and thus a maximum of 64 SSBs 761 may be transmitted.

A terminal may decode a PDCCH and a PDSCH, based on system information included in an MIB received from a BS, and then obtain an SIB. The SIB may include at least one of UL cell bandwidth-related information, a random access parameter, a paging parameter, or a parameter related to UL power control.

Generally, a terminal may establish a wireless link with a network through a random access procedure, based on system information and synchronization with the network, obtained in a cell search process for a cell. A contention-based scheme or a contention-free scheme may be used for random access. For example, when a terminal performs cell selection and reselection in an initial cell access stage, a contention-based random access scheme may be used to transition from an RRC_IDLE state to an RRC_CONNECTED state. Contention-free random access may be used to reconfigure UL synchronization when DL data has arrived, in handover, or positioning. Table 3 below may include conditions (events) to trigger a random access procedure in a 5G system.

```
TABLE 3
  - Initial access from RRC_IDLE;
  - RRC Connection Re-establishment procedure;
    - DL or UL data arrival during RRC_CONNECTED when UL
synchronization status is ″non-synchronized″;
  - UL data arrival during RRC CONNECTED when there are no PUCCH
resources
for SR available;
  - SR failure;
  - Request by RRC upon synchronous reconfiguration (e.g. handover);
  - RRC Connection Resume procedure from RRC_INACTIVE;
  - To establish time alignment for a secondary TAG:
  - Request for Other SI;
  - Beam failure recovery;
  - Consistent UL LBT failure on SpCell.
```

Hereinafter, a measurement time configuring method for radio resource management (RRM) based on SSBs in a 5G communication system is described. The MeasObjectNR of the MeasObjectToAddModList may be configured for a terminal as a configuration for intrainter-frequency signal measurements (intra/inter-frequency measurements) based on SSBs and intra/inter-frequency measurements based on channel state information-reference signals (CSI-RSs) through higher layer signaling (e.g., an RRC message). For example, MeasObjectNR may be configured as shown below in Table 4.

TABLE 4

```
MeasObjectNR ::=  SEQUENCE {
    ssbFrequency  ARFCN-ValueNR
OPTIONAL,  -- Cond SSBorAssociatedSSB
    ssbSubcarrierSpacing  SubcarrierSpacing
OPTIONAL,  -- Cond SSBorAssociatedSSB
    smtc2  SSB-MTC
OPTIONAL,  -- Cond SSBorAssociatedSSB
    smtc2  SSB-MTC2
OPTIONAL,  -- Cond IntraFreqConnected
    refFreqCSI-RS  ARFCN-ValueNR
OPTIONAL,  -- Cond CSI-RS
    referenceSignalConfig  ReferenceSignalConfig,
    absThreshSS-BlocksConsolidation  ThresholdNR
OPTIONAL,  -- Need R
    absThreshCSI-RS-Consolidation  ThresholdNR
OPTIONAL,  -- Need R
    nrofSS-BlocksToAverage  INTEGER (2..maxNrofSS-
BlocksToAverage)  OPTIONAL,  -- Need R
    nrofCSI-RS-ResourcesToAverage  INTEGER (2..maxNrofCSI-RS-
ResourcesToAverage)  OPTIONAL,  -- Need R
    quantityConfigIndex  INTEGER
(1..maxNrofQuantityConfig),
    offsetMO  Q-OffsetRangeList,
    cellsToRemoveList  PCI-List
OPTIONAL,  -- Need N
    cellsToAddModList  CellsToAddModList
OPTIONAL,  -- Need N
    blackCellsToRemoveList  PCI-RangeIndexList
OPTIONAL,  -- Need N
    blackCellsToAddModList  SEQUENCE (SIZE
(1..maxNrofPCI-Ranges)) OF PCI-RangeElement  OPTIONAL,  -- Need
N
    whiteCellsToRemoveList  PCI-RangeIndexList
OPTIONAL,  -- Need N
    whiteCellsToAddModList  SEQUENCE (SIZE
(1..maxNrofPCI-Ranges)) OF PCI-RangeElement  OPTIONAL,  -- Need
N
    ...,
    [[
    freqBandIndicatorNR  FreqBandIndicatorNR
OPTIONAL,  -- Need R
    measCycleSCell  ENUMERATED {sf160, sf256,
sf320, sf512, sf640, sf1024, sf1280} OPTIONAL  -- Need R
    ]],
    [[
    smtc3list-r16  SSB-MTC3List-r16
OPTIONAL,  -- Need R
    rmtc-Config-r16  SetupRelease {RMTC-Config-r16}
OPTIONAL,  -- Need M
    t312-r16  SetupRelease { T312-r16 }
OPTIONAL -- Need M
    ]],
}
```

The ssbFrequency may configure the frequency of a synchronization signal related to MeasObjectNR.

The ssbSubcarrierSpacing may configure the subcarrier spacing of an SSB. In FR1, only 15 kHz or 30 kHz is applicable, and in FR2, only 120 kHz or 240 kHz is applicable.

The smtc1 indicates an SS/PBCH block measurement timing configuration, and may configure a primary measurement timing configuration and configure a timing offset and a duration for an SSB.

The smtc2 configures a secondary measurement timing configuration for an SSB related to MeasObjectNR having a PCI listed in pci-List.

An smtc may also be configured through different higher layer signaling. For example, an smtc may also be configured for a terminal through an SIB2 for intra-frequency, inter-frequency, or inter-radio access technology (RAT) cell re-selection, or reconfigurationWithSync for NR Pcell change. Alternatively, an smtc may be configured for a terminal through SCellConfig for NR SCell addition.

A BS may configure, for a terminal, a first SS/PBCH block measurement timing configuration (SMTC) according to periodictiyAndOffset (e.g., providing a period and an offset) through smtc1 configured through higher layer signaling for SSB measurement. The first subframe of each SMTC occasion may start at a subframe of an SPCell and an SFN satisfying a condition shown below in Table 5.

TABLE 5

```
SFN mod T= (FLOOR (Offset/10));
if the Periodicity is larger than sf5:
        subframe = Offset mod 10;
else:
        subframe = Offset or (Offset +5);
with T=CEIL(Periodicity/10).
```

If smtc2 is configured, a terminal may configure, for cells indicated by pci-List values of smtc2 in the same MeasObjectNR, an additional SMTC according to an offset and a duration of smtc1 and a period (periodicity) of the configured smtc2. Alternatively, a base station may configure, for a terminal, an smtc through smtc2-LP and smtc3list for integrated access and backhaul-mobile termination (IAB-MT), and the terminal may measure an SSB through the smtc. smtc2-LP is for the same frequency (e.g., frequency for intra-frequency cell re-selection) or a different frequency (e.g., frequency for inter-frequency cell re-selection), and may have a period. According to ssbFrequency configured by a base station, a terminal may not consider an SSB transmitted in subframes other than SMTC occasions for RRM measurement based on SSBs.

A base station may use various multi-transmit/receive point (TRP) operating methods according to a serving cell configuration and a PCI configuration. When two TRPs physically located far away from each other have different PCIs, there may be two methods of operating the two TRPs.

Method 1

Two TRPs having different PCIs may be operated by two serving cell configurations.

A base station may configure channels and signals transmitted from different TRPs to be included in different serving cell configurations through Method 1. That is, each TRP may have an independent serving cell configuration, and values of FrequencyInfoDL, which indicates a frequency band value indicated by DLConfigCommon in each serving cell configuration, may indicate bands that at least partially overlap with each other. Multiple TRPs operate based on multiple values of ServCellIndex (e.g., ServCellIndex #1 and ServCellIndex #2), and thus each TRP may use a separate PCI. That is, a base station may assign one PCI per ServCellIndex.

When one PCI is assigned per ServCellIndex, when several SSBs are transmitted from TRP 1 and TRP 2, the SSBs may have different PCIs (e.g., PCI #1 and PCI #2), and a base station may properly select a ServCellIndex value indicated as a cell parameter in quasi colocation (QCL)-Info and map a PCI suitable for each TRP thereto, and may designate an SSB transmitted from one of TRP 1 or TRP 2 as a source RS of QCL configuration information. However, the above configuration indicates applying one serving cell configuration available for carrier aggregation (CA) of a terminal to multiple TRPs, and thus the freedom of CA configuration may be limited or the signaling burden may be increased.

Method 2

Two TRPs having different PCIs may be operated by one serving cell configuration.

A base station may configure channels and signals transmitted from different TRPs through one serving cell configuration by Method 2. A terminal operates based on one ServCellIndex value (e.g., ServCellIndex #1), and thus may be unable to recognize a PCI (e.g., PCI #2) assigned to a second TRP. Method 2 may have the freedom of CA configuration compared to Method 1 described above. However, when multiple SSBs are transmitted from TRP 1 and TRP 2, the SSBs may have different PCIs (e.g., PCI #1 and PCI #2), and a base station may be unable to map PCI #2 of the second TRP through ServCellIndex indicated as a cell parameter in QCL-Info. The base station may be able to only designate an SSB transmitted from TRP 1 as a source RS of QCL configuration information, and may be unable to designate an SSB transmitted from TRP 2.

Method 1 may perform multi-TRP operation for two TRPs having different PCIs through an additional serving cell configuration without additional specification support. However, Method 2 may operate based on an additional terminal capability report and configuration information of a base station described below.

Related to Terminal Capability Reporting for Method 2:

A terminal may transmit, to a base station, a terminal capability report indicating that a configuration for an additional PCI other than the PCI of a serving cell configured through higher layer signaling (e.g., RRC message) received from the base station is possible. Two independent numbers X1 and X2 may be included in one terminal capability report or may be transmitted to a base station through independent terminal capability reports.

X1 may denote a maximum number of additional PCIs configurable for a terminal, and the additional PCIs may be different from the PCI of a serving cell. The time domain position and the period of an SSB corresponding to an additional PCI may be the same as those of an SSB of a serving cell.

X2 may denote a maximum number of additional PCIs configurable for a terminal, and the additional PCIs may be different from the PCI of a serving cell. The time domain position and the period of an SSB corresponding to an additional PCI may be different from those of an SSB corresponding to a PCI reported as X1.

According to the above definitions of X1 and X2, simultaneous configuration of PCIs corresponding to values reported as X1 and X2 may be difficult.

X1 and X2 included in a terminal capability report may be an integer among 0 to 7 and may have different values in FR1 and FR2.

Related to Higher Layer Signaling Configuration for Method 2:

SSB-MTCAdditionalPCI-r17 may be configured for a terminal through higher layer signaling (e.g., RRC message), based on a terminal capability report described above.—Higher layer signaling (e.g., RRC message) may include multiple additional PCIs different from that of at least a serving cell, SSB transmission power corresponding to each additional PCI, and ssb-PositionInBurst corresponding to each additional PCI, and a maximum of seven additional PCIs may be configured.

A terminal may assume that an SSB corresponding to an additional PCI different from that of a serving cell has the same center frequency, subcarrier spacing, and subframe number offset as an SSB of a serving cell.

A terminal may assume that an RS (e.g., SSB or CSI-RS) corresponding to the PCI of a serving cell is always connected to an activated TCI state, and when an additional PCI different from that of a serving cell is configured, only one PCI among one or multiple additional PCIs is connected to an activated TCI state.

When two different coresetPoolIndexs are configured for a terminal, an RS corresponding to the PCI of a serving cell is connected to one or multiple activated TCI states, and an RS corresponding to an additional configured PCI different from that of the serving cell is connected to one or multiple activated TCI states, the terminal may expect that the activated TCI state(s) connected to the PCI of the serving cell may be connected to one of the two different coresetPoolIndexs and the activated TCI state(s) connected to the additional configured PCI different from that of the serving cell is connected to the remaining one coresetPoolIndex.

Terminal capability reporting and higher layer signaling (e.g., RRC message) of a base station for Method 2 described above may include a configuration for an additional PCI different from the PCI of a serving cell. When there is no configuration for an additional PCI, an SSB corresponding to an additional PCI different from the PCI of a serving cell, which is unable to be designated as a source RS, may be used to be designated as a source RS of QCL configuration information. In addition, unlike an SSB that may be configured to be used for RRM, mobility, or handover, an SSB corresponding to an additional PCI may be used to serve as a QCL source RS for supporting an operation for multiple TRPs having different PCIs similarly to configuration information on an SSB which may be included in smtc1 and smtc2 in higher layer signaling (e.g., RRC message).

A DMRS may be configured by several DMRS ports, and each port may maintain orthogonality by using code division multiplexing (CDM) or frequency division multiplexing (FDM), so as not to generate mutual interference. However, terms for DMRSs may be replaced with different terms according to a user's intent and the purpose of using reference signals. The term DMRS corresponds to a particular example so as to easily describe technical contents of the disclosure and is not intended to limit the scope of the disclosure.

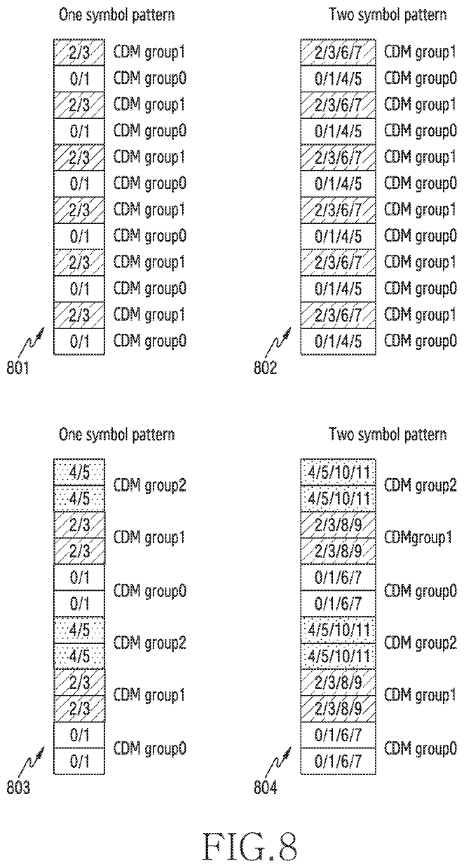

FIG. 8 illustrates a DMRS pattern used in communication between a base station and a terminal in a 5G system according to an embodiment of the disclosure. Two DMRS patterns (e.g., type 1 and type 2) may be supported in a 5G system.

Referring to FIG. 8, reference numerals 801 and 802 may correspond to DMRS type 1, reference numeral 801 indicates a 1-symbol pattern, and reference numeral 802 may indicate a 2-symbol pattern. DMRS type 1 of reference numerals 801 and 802 corresponds to a DMRS pattern having a comb-2 structure, and may be configured by two CDM groups, and different CDM groups may be FDMed. The comb indicates a method by which a DMRS is mapped to a resource block, and that a DMRS configured by the same DMRS port is mapped to subcarriers having a predetermined gap. For example, comb 2 may imply configuring 2 as the subcarrier index difference in a DMRS configured by the same DMRS port (e.g., a DMRS configured by DMRS port 0 is positioned in subcarrier indexes 0, 2, 4, 6, 8, and 10).

In the 1-symbol pattern 801, CDM may be applied to the same CDM group in the frequency domain so that two DMRS ports may be distinguished, and a total of four orthogonal DMRS ports may be configured. The 1-symbol pattern 801 may include DMRS port IDs mapped to each CDM group. For example, a DMRS port ID for DL may be represented by an illustrated number+1000. In the 2-symbol pattern 802, CDM may be applied to the same CDM group in the time/frequency domain so that four DMRS ports may be distinguished, and a total of eight orthogonal DMRS ports may be configured. The 2-symbol pattern 802 may include DMRS port IDs mapped to each CDM group. For example, a DMRS port ID for DL may be represented by an illustrated number+1000.

DMRS type 2 indicated by reference numerals 803 and 804 corresponds to a DMRS pattern having a structure in which frequency domain orthogonal cover codes (FD-OCC) are applied to neighboring subcarriers in the frequency domain, and may be configured by three CDM groups. Different CDM groups may be FDMed.

In the 1-symbol pattern 803, CDM may be applied to the same CDM group in the frequency domain so that two DMRS ports may be distinguished, and a total of six orthogonal DMRS ports may be configured. The 1-symbol pattern 803 may include DMRS port IDs mapped to each CDM group. For example, a DMRS port ID for DL may be represented by an illustrated number+1000. In the 2-symbol pattern 804, CDM may be applied to the same CDM group in the time/frequency domain so that four DMRS ports may be distinguished, and a total of 12 orthogonal DMRS ports may be configured. The 2-symbol pattern 804 may include DMRS port IDs mapped to each CDM group. For example, a DMRS port ID for DL may be represented by an illustrated number+1000.

As described above, in a 5G system, DMRS patterns 801 and 802 or DMRS patterns 803 and 804 may be configured, and whether each DMRS pattern is the 1(one)-symbol pattern 801 or 803, or the adjacent 2(two)-symbol pattern 802 or 804 may be also configured. In addition, in a 5G system, a DMRS port number is scheduled, and the number of CDM groups scheduled together for PDSCH rate matching may be configured (or signaled). In cyclic prefix based orthogonal frequency division multiplexing (CP-OFDM), both of the two DMRS patterns described above may be supported in the DL and UL, and in discrete Fourier transform spread OFDM (DFT-S-OFDM), only DMRS type 1 among the above DMRS patterns may be supported in the UL.

A 5G system may support that an additional DMRS is configurable. A front-loaded DMRS may indicate a first DMRS transmitted or received in the foremost symbol in the time domain among DMRSs, and an additional DMRS may indicate a DMRS transmitted and/or received in a symbol after the front-loaded DMRS in the time domain. In a 5G system, the number of additional DMRSs may be configured to one among 0 to 3. When an additional DMRS is configured, the additional DMRS may have the same pattern as a front-loaded DMRS.

When information relating to whether the described DMRS pattern type is type 1 or type 2, information relating to whether the DMRS pattern is a 1-symbol pattern or an adjacent 2-symbol pattern, and information on the number of CDM groups used with DMRS ports are indicated for a front-loaded DMRS, when an additional DMRS is configured, the same DMRS information as the front-loaded DMRS may be configured for the additional DMRS.

A DL DMRS configuration as described above may be configured through higher layer signaling (e.g., RRC message) as shown below in Table 6.

TABLE 6

| | | |
|---|---|---|
| DMRS- | SEQUENCE { | |
| DownlinkConfig ::= | ENUMERATED { type2} | OPTIONAL, |
| dmrs-Type | -- Need S | |
| dmrs- | ENUMERATED {pos0, pos1, pos3} | OPTIONAL, |
| AdditionalPosition | -- Need S | |
| maxLength | ENUMERATED {len2} | OPTIONAL, |
| scramblingID0 | -- Need S | |
| scramblingID1 | INTEGER (0..65535) | OPTIONAL, |
| phase TrackingRS | -- Need S | |
| ... | INTEGER (0..65535) | OPTIONAL, |
| } | -- Need S | |
| | SetupRelease {PTRS-DownlinkConfig} | OPTIONAL, |
| | -- Need M | |

In Table 6, dmrs-Type may include configuration information on a DMRS type, dmrs-AdditionalPosition may include configuration information on additional DMRS OFDM symbols, maxLength may include configuration information on a 1-symbol DRMS pattern or a 2-symbol DMRS pattern, scramblingID0 and scramblingID1 may include configuration information on scrambling IDs, and phaseTrackingRS may include configuration information on a phase tracking reference signal (PTRS).

In addition, a UL DMRS configuration as described above may be configured through higher layer signaling (e.g., RRC message) as shown below in Table 7.

TABLE 7
DMRS-UplinkConfig ::= SEQUENCE {

| dmrs-Type | ENUMERATED {type2] OPTIONAL, -- Need S | |
|---|---|---|
| dmrs-AdditionalPosition | ENUMERATED {pos0, pos1, | OPTIONAL, -- Need |
| phaseTrackingRS | pos3} | OPTIONAL, R |
| maxLength | SetupRelease {PTRS-Uplink | OPTIONAL, -- Need |

| | |
|---|---|
| transformPrecodingDisabled Config} | M |

| | | |
|---|---|---|
| scramblingID0 | ENUMERATED (len2) | OPTIONAL, -- Need |
| scramblingID1 | SEQUENCE { | OPTIONAL, S |
| ... | INTEGER (0..65535) | |
| } | INTEGER (0..65535) | OPTIONAL, -- Need |
| transformPrecodingEnabled | | S |
| nPUSCH-Identity | | OPTIONAL, -- Need |
| sequenceGroupHopping | SEQUENCE { | OPTIONAL, S |
| sequenceHopping | INTEGER (0..1007) | OPTIONAL, |
| ... | ENUMERATED {disabled} | -- Need |
| } | ENUMERATED {enabled} | OPTIONAL, R |
| ... | | |
| } | | -- Need |
| | | S |
| | | -- Need |
| | | S |
| | | -- Need |
| | | S |
| | | -- Need |
| | | R |

In Table 7, dmrs-Type may include configuration information on a DMRS type, dmrs-AdditionalPosition may include configuration information on additional DMRS OFDM symbols, phaseTrackingRS may include configuration information on a PTRS, and maxLength may include configuration information on a 1-symbol DRMS pattern or a 2-symbol DMRS pattern. The scramblingID0 and scramblingID1 may include configuration information on scrambling ID0s, nPUSCH-Identity may include configuration information on a cell ID for DFT-s-OFDM, sequenceGroupHopping may disable sequence group hopping, and sequenceHopping may enable sequence hopping.

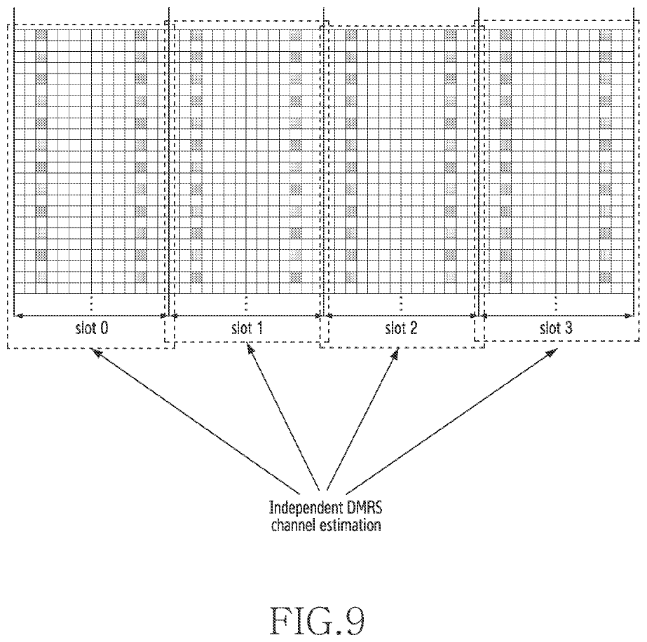

FIG. 9 illustrates an example of channel estimation using a DMRS received in one PUSCH in a time band of a 5G system according to an embodiment of the disclosure.

Referring to FIG. 9, in channel estimation for data decoding using a DMRS, the channel estimation may be performed in a precoding resource block group (PRG), which is a unit of bundling, by using bundling of physical resource blocks (PRBs) linked to a system band in the frequency domain. In the time domain, channel estimation may be performed under the assumption that precoding is the same for only DMRSs received in one PUSCH.

Hereinafter, a time domain resource allocation (TDRA) method for a data channel in a 5G system will be described. A BS may configure, for a terminal, a table relating to time domain resource allocation information for a downlink data channel (e.g., PDSCH) and an uplink data channel (e.g., PUSCH) through higher layer signaling (e.g., RRC message).

The BS may configure a table configured by a maximum of 17 (e.g., maxNrofDL-Allocations is equal to 17) entries for a PDSCH, and a table configured by a maximum of 17 (e.g., maxNrofUL-Allocations is equal to 17) entries may be configured for a PUSCH. For example, time domain resource allocation information may include at least one of a PDCCH-to-PDSCH slot timing corresponding to a time interval expressed in the unit of slots between a time point of reception of a PDCCH and a time point of transmission of a PDSCH scheduled by the received PDCCH, the timing being indicated by KO, or a PDCCH-to-PUSCH slot timing corresponding to a time interval expressed in the unit of slots between a time point of reception of a PDCCH and a time point of transmission of a PUSCH scheduled by the received PDCCH, the timing being indicated by K2, information on the length and the starting symbol position of a PDSCH or a PUSCH scheduled in a slot, and a mapping type of a PDSCH or a PUSCH. A PDCCH-to-PDSCH slot timing may be expressed in the unit of slots between a time point of reception of a PDCCH and a time point of transmission of a PDSCH scheduled by the received PDCCH, and may be represented by KO. A PDCCH-to-PUSCH slot timing may be expressed in the unit of slots between a time point of reception of a PDCCH and a time point of transmission of a PUSCH scheduled by the received PDCCH, and may be represented by K2.

Time domain resource allocation information for a PDSCH may be configured for the terminal through higher layer signaling (e.g., RRC message) as shown below in Table 8.

TABLE 8

```
PDSCH-TimeDomainResourceAllocationList information element
PDSCH-TimeDomainResourceAllocationList ::=  SEQUENCE (SIZE(1..maxNrofDL-
Allocations)) OF PDSCH-TimeDomainResourceAllocation
PDSCH-TimeDomainResourceAllocation ::=  SEQUENCE {
    k0  INTEGER(0..32)  OPTIONAL,  -- Need
                      S
    mappingType  ENUMERATED {typeA,
                      typeB},
    startSymbolAndLength INTEGER (0..127)
    repetitionNumber  ENUMERATED {n2, n3, n4, n5, n6, n7, n8, n16}
OPTIONAL,  -- Cond
Formats1-0and1-1
}
```

In Table 8, k0 may express a PDCCH-to-PDSCH timing (e.g., a slot offset between DCI and a scheduled PDSCH) in the unit of slots, mappingType may represent a PDSCH mapping type, startSymbolAndLength may represent the starting symbol and length of a PDSCH, and repetitionNumber may express the number of PDSCH transmission occasions according to a slot-based repetition scheme.

Time domain resource allocation information for a PUSCH may be configured for the terminal through higher layer signaling (e.g., RRC message) as shown below in Table 9.

TABLE 9

```
PUSCH-TimeDomainResourceAllocation information element
PUSCH-TimeDomainResourceAllocationList ::=  SEQUENCE
(SIZE(1..maxNrofUL-Allocations)) OF PUSCH-TimeDomainResourceAllocation
PUSCH-TimeDomainResourceAllocation ::=  SEQUENCE {
    k2  INTEGER (0..32)
OPTIONAL, -- Need S
    mappingType  ENUMERATED {typeA, typeB},
    startSymbolAndLength  INTEGER (0..127)
}
PUSCH-Allocation-r16 ::= SEQUENCE {
  mappingType-r16  ENUMERATED {typeA, typeB}
OPTIONAL, -- Cond NotFormat01-02-Or-TypeA
  startSymbolAndLength-r16  INTEGER (0..127)  (0..OPTIONAL, --
Cond NotFormat01-02-Or-TypeA
  startSymbol-r16  INTEGER (0..13)  OPTIONAL,  --
Cond RepTypeB
  length-r16  INTEGER (1..14)  OPTIONAL, --
Cond RepTypeB
  numberOfRepetitions-r16  ENUMERATED {n1, n2, n3, n4, n7, n8, n12, n16}
OPTIONAL, -- Cond Format01-02
    ...
}
```

In Table 9, k2 may express a PDCCH-to-PUSCH timing (e.g., a slot offset between DCI and a scheduled PUSCH) in the unit of slots, mappingType may represent a PUSCH mapping type, startSymbolAndLength or StartSymbol and length may represent the starting symbol and length of a PUSCH, and numberOfRepetitions may represent the number of times of repetition applied to PUSCH transmission.

The BS may indicate, to the terminal, at least one of the entries of a table relating to time domain resource allocation information through L1 signaling (e.g., downlink control information (DCI)). For example, the BS may indicate, to the terminal, at least one of the entries of a table relating to time domain resource allocation information by using a time domain resource allocation field in DCI. The terminal may obtain time domain resource allocation information for a PDSCH or PUSCH, based on L1 signaling (e.g., DCI) received from the BS.

PUSCH transmission may be dynamically scheduled by a UL grant in DCI (e.g., dynamic grant (DG)-PUSCH), or may be scheduled by configured grant Type 1 or configured grant Type 2 (e.g., configured grant (CG)-PUSCH). For example, dynamic scheduling for PUSCH transmission may be indicated by DCI format 0_0 or 0_1.

PUSCH transmission of configured grant Type 1 may be semi-statically scheduled through configuredGrantConfig including rrc-ConfiguredUplinkGrant shown below in Table 10 included in higher layer signaling (e.g., RRC message) without reception of a UL grant in DCI. PUSCH transmission of configured grant Type 2 may be semi-persistently scheduled by a UL grant in DCI after a terminal receives, from a BS, configuredGrantConfig not including rrc-ConfiguredUplinkGrant in Table 10 through higher layer signaling (e.g., RRC message).

When PUSCH transmission is scheduled by a configured grant, parameters applied to the PUSCH transmission may be configured through configuredGrantConfig, which is in higher layer signaling (e.g., RRC message) of Table 10, except for specific parameters (e.g., dataScramblingIdentityPUSCH, txConfig, codebookSubset, maxRank, or scaling of UCI-OnPUSCH) provided as pusch-Config in Table 11, which is in higher layer signaling (e.g., RRC message). For example, when transformPrecoder in configuredGrantConfig, which is higher layer signaling (e.g., RRC message) of Table 10, is provided to a terminal, the terminal may apply tp-pi2BPSK in pusch-Config of Table 11 below to PUSCH transmission operated by a configured grant.

TABLE 10

```
ConfiguredGrantConfig
ConfiguredGrantConfig ::=  SEQUENCE {
  frequencyHopping  ENUMERATED {intraSlot, interSlot}
OPTIONAL,  -- Need S
  cg-DMRS-Configuration  DMRS-UplinkConfig,
  mcs-Table  ENUMERATED {qam256, qam64LowSE}
OPTIONAL,  -- Need S
  mcs-TableTransformPrecoder  ENUMERATED {qam256, qam64LowSE}
OPTIONAL,  -- Need S
  uci-OnPUSCH  SetupRelease { CG-UCI-OnPUSCH}
OPTIONAL,  -- Need M
  resourceAllocation  ENUMERATED { resourceAllocationType0,
resourceAllocationType1, dynamicSwitch },
  rbg-Size  ENUMERATED {config2}
OPTIONAL,  -- Need S
  powerControlLoopToUse  ENUMERATED {n0, n1},
  p0-PUSCH-Alpha  P0-PUSCH-AlphaSetId,
  transformPrecoder  ENUMERATED {enabled, disabled}
OPTIONAL,  -- Need S
  nrofHARQ-Processes  INTEGER(1..17),
  repK  ENUMERATED {n1, n2, n4, n8},
  repK-RV  ENUMERATED {s1-0231, s2-0303, s3-
0000}  OPTIONAL,  -- Need R
  periodicity  ENUMERATED {
  sym2, sym7, sym1x14, sym2x14, sym4x14, sym5x14, sym8x14, sym10x14,
sym17x14, sym20x14,
  sym32x14, sym40x14, sym64x14, sym80x14, sym128x14, sym170x14, sym256x14,
sym320x14, sym512x14,
  sym640x14, sym1024x14, sym1280x14, sym2560x14, sym5120x14,
  sym6, sym1x12, sym2x12, sym4x12, sym5x12, sym8x12, sym10x12, sym17x12,
sym20x12, sym32x12,
  sym40x12,  sym64x12,  sym80x12,  sym128x12,  sym170x12,  sym256x12,
sym320x12, sym512x12, sym640x12,
  sym1280x12, sym2560x12
  },
  configuredGrantTimer  INTEGER (1..64)
OPTIONAL,  -- Need R
  rrc-ConfiguredUplinkGrant  SEQUENCE {
    timeDomainOffset  INTEGER (0..5119),
    timeDomainAllocation  INTEGER (0..16),
    frequencyDomainAllocation  BIT STRING (SIZE(18)),
    antennaPort  INTEGER (0..31),
    dmrs-SeqInitialization  INTEGER (0..1)
OPTIONAL,  -- Need R
    precodingAndNumberOfLayers  INTEGER (0..63),
    srs-ResourceIndicator  INTEGER (0..16)
OPTIONAL,  -- Need R
    mcsAndTBS  INTEGER (0..31),
    frequencyHoppingOffset  INTEGER (1..
maxNrofPhysicalResourceBlocks-1)  OPTIONAL,  -- Need R
    pathlossReferenceIndex  INTEGER
(0..maxNrofPUSCH-PathlossReferenceRSs-1),
    ...
  }
OPTIONAL,  -- Need R
  ...
}
```

A DMRS antenna port for PUSCH transmission may be the same as an antenna port for SRS transmission. A PUSCH transmission method may be classified as a codebook-based transmission method or a non-codebook-based transmission method according to whether the value of txConfig in pusch-Config of Table 7, which is higher layer signaling (e.g., RRC message), is a “codebook” or a “nonCodebook”. As described above, PUSCH transmission may be dynamically scheduled through DCI format 0_0 or 0_1, or may be semi-statically scheduled by a configured grant.

If a BS indicates, to a terminal, scheduling for PUSCH transmission through DCI format 0_0, the terminal may perform beam configuration for the PUSCH transmission by using pucch-spatialRelationInfoID corresponding to a terminal (UE)-specific (dedicated) PUCCH resource having the lowest ID in an activated UL bandwidth part (BWP) in a serving cell. PUSCH transmission may be performed based on a single antenna port and may not be scheduled for a terminal through DCI format 0_0 within a BWP in which a PUCCH resource including pucch-spatialRelationInfo is not configured. When txConfig in pusch-Config of Table 11 below is not configured for a terminal, PUSCH transmission may not be scheduled for the terminal through DCI format 0_1.

TABLE 11

```
PUSCH-Config
PUSCH-Config ::=  SEQUENCE {
  dataScramblingldentityPUSCH  INTEGER (0..1023)
OPTIONAL,  -- Need S
  txConfig  ENUMERATED {codebook, nonCodebook}
OPTIONAL, -- Need S
  dmrs-UplinkForPUSCH-MappingTypeA  SetupRelease { DMRS-
UplinkConfig } OPTIONAL, -- Need M
  dmrs-UplinkForPUSCH-MappingTypeB  SetupRelease { DMRS-
UplinkConfig } OPTIONAL, -- Need M
  pusch-PowerControl  PUSCH-PowerControl
OPTIONAL, -- Need M
  frequencyHopping  ENUMERATED {intraSlot,
interSlot}  OPTIONAL, -- Need S
  frequencyHoppingOffsetLists  SEQUENCE (SIZE (1..4)) OF INTEGER
(1..maxNrofPhysicalResourceBlocks-1)  OPTIONAL, -- Need M
  resource Allocation  ENUMERATED
{ resourceAllocationType0, resource AllocationType1, dynamicSwitch},
  pusch-TimeDomainAllocationList  SetupRelease { PUSCH-
TimeDomainResourceAllocationList } OPTIONAL, -- Need M
  pusch-AggregationFactor  ENUMERATED { n2, n4, n8 }
OPTIONAL,  -- Need S
  mcs-Table  ENUMERATED {qam256,
qam64LowSE}  OPTIONAL,  -- Need S
  mcs-TableTransformPrecoder  ENUMERATED {qam256,
qam64LowSE}  OPTIONAL,  -- Need S
  transformPrecoder  ENUMERATED {enabled, disabled}
OPTIONAL,  -- Need S
  codebookSubset  ENUMERATED  {fully AndPartialAndNonCoherent,
partialAndNonCoherent, nonCoherent}
                  OPTIONAL, -- Cond codebookBased
  maxRank  INTEGER (1..4)
OPTIONAL, -- Cond codebookBased
  rbg-Size  ENUMERATED { config2}
OPTIONAL,  -- Need S
  uci-OnPUSCH  SetupRelease { UCI-OnPUSCH }
OPTIONAL,  -- Need M
  tp-pi2BPSK  ENUMERATED {enabled}
OPTIONAL,  -- Need S
  ...
}
```

Codebook-based PUSCH transmission may be dynamically scheduled through DCI format 0_0 or 0_1, or may be semi-statically scheduled by a configured grant. If dynamical scheduling is performed by a codebook-based PUSCH DCI format 0_1, or semi-static scheduling is performed by a configured grant, a terminal may determine a precoder for PUSCH transmission, based on an SRS resource indicator (SRI), a transmission precoding matrix indicator (TPMI), and a transmission rank (e.g., the number of PUSCH transmission layers).

An SRI may be indicated through an SRS resource indicator, which is a field in DCI, or may be configured through srs-ResourceIndicator which is higher layer signaling (e.g., RRC message). When a codebook-based PUSCH transmission is performed by a terminal, at least one SRS resource may be configured for the terminal. For example, a maximum of two SRS resources may be configured for a terminal. When a BS indicates an SRI to a terminal through DCI, an SRS resource indicated by the indicated SRI may indicate an SRS resource corresponding to the SRI among SRS resources transmitted before a PDCCH including the indicated SRI. A TPMI and a transmission rank may be indicated through precoding information and number of layers, which is a field in DCI, may be configured through precodingAndNumberOfLayers of higher layer signaling (e.g., RRC message), and may be used to indicate a precoder applied to PUSCH transmission.

A precoder to be used for PUSCH transmission may be selected in a UL codebook having a number of antenna ports corresponding to the value of nrofSRS-Ports in SRS-Config of higher layer signaling (e.g., RRC message). In codebook-based PUSCH transmission, a terminal may determine a codebook subset, based on a TPMI and codebookSubset in pusch-Config of higher layer signaling (e.g., RRC message). The codebookSubset in pusch-Config of higher layer signaling (e.g., RRC message) may be configured as one of fullyAndPartialAndNonCoherent, partialAndNonCoherent, or nonCoherent, based on a UE capability report having transmitted by a terminal to a BS.

If a terminal has reported partialAndNonCoherent through a terminal capability report, the value of codebookSubset of higher layer signaling (e.g., RRC message) may not be configured as fullyAndPartialAndNonCoherent. In addition, if a terminal has reported nonCoherent as a terminal capability report, the value of codebookSubset of higher layer signaling (e.g., RRC message) may not be configured as fullyAndPartialAndNonCoherent or partialAndNonCoherent. If nrofSRS-Ports in SRS-ResourceSet of higher layer signaling (e.g., RRC message) indicates two SRS antenna ports, the value of codebookSubset of higher layer signaling (e.g., RRC message) may not be configured as partialAndNonCoherent.

One SRS resource set for which the codebook is configured as the value of usage in SRS-ResourceSet of higher layer signaling (e.g., RRC message) may be configured for a terminal, and one SRS resource in the SRS resource set configured for the terminal may be indicated through an SRI. If several SRS resources are configured in an SRS resource set for which the codebook is configured as the value of usage in SRS-ResourceSet of higher layer signaling (e.g., RRC message), the value of nrofSRS-Ports in SRS-Resource of higher layer signaling (e.g., RRC message) may be configured to be the same for all the SRS resources.

A terminal may transmit, to a BS, one or multiple SRS resources included in an SRS resource set for which the codebook is configured as the value of usage according to higher layer signaling (e.g., RRC message). The BS may select one of the SRS resources transmitted by the terminal, and may indicate the terminal to perform PUSCH transmission by using transmission beam information of the selected SRS resource. In codebook-based PUSCH transmission, an SRI may be used as information for selecting the index of one SRS resource, and may be included in DCI. Additionally, a BS may include, in DCI, information indicating a TPMI and a rank to be used by a terminal for PUSCH transmission, and transmit the DCI and the information to the terminal. A terminal may use an SRS resource indicated by an SRI and apply a precoder indicated by a TPMI and a rank indicated by DCI, based on a transmission beam of the indicated SRS resource, so as to perform PUSCH transmission.

Non-codebook-based PUSCH transmission may be dynamically scheduled through DCI format 0_0 or 0_1, or may be semi-statically scheduled by a configured grant. When at least one SRS resource is configured in an SRS resource set for which a nonCodebook is configured as the value of usage in SRS-ResourceSet of higher layer signaling (e.g., RRC message), a BS may schedule non-codebook-based PUSCH transmission for a terminal through DCI format 0_1.

With respect to an SRS resource set for which a nonCodebook is configured as the value of usage in SRS-ResourceSet of higher layer signaling (e.g., RRC message), a BS may configure a non-zero power (NZP) CSI-RS resource associated with one SRS resource set for a terminal. A terminal may perform a calculation for a precoder for SRS transmission through a measurement of an NZP CSI-RS resource configured in association with an SRS resource set. When the difference between the first symbol of aperiodic SRS transmission by a terminal, and the last reception symbol of an aperiodic NZP CSI_RS resource associated with an SRS resource set is smaller than a particular symbol (e.g., 42 symbols), information on a precoder for SRS transmission may not be updated.

If aperiodic is configured as the value of resourceType in SRS-ResourceSet of higher layer signaling (e.g., RRC message), an NZP CSI-RS associated with SRS-ResourceSet may be indicated by SRS request which is a field in DCI format 0_1 or 1_1. When an NZP CSI-RS resource associated with SRS-ResourceSet is an aperiodic NZP CSI resource, and the value of SRS request which is a field in DCI format 0_1 or 1_1 is not 00, the value of SRS request may indicate that an NZP CSI-RS associated with SRS-ResourceSet exists. DCI may not indicate cross carrier or cross BWP scheduling. When the value of SRS request indicates existence of an NZP CSI-RS, the NZP CSI-RS may be positioned in a slot in which a PDCCH including the SRS request field is transmitted. TCI states configured for a scheduled subcarrier may not be configured as QCL-TypeD.

When a periodic or semi-persistent SRS resource set is configured, an NZP CSI-RS associated with the SRS resource set may be configured for a terminal through associatedCSI-RS in SRS-ResourceSet of higher layer signaling (e.g., RRC message). In non-codebook-based transmission, associatedCSI-RS in SRS-ResourceSet and spatialRelationInfo of higher layer signaling (e.g., RRC message) for SRS resources may not be configured together.

When multiple SRS resources are configured for a terminal, the terminal may determine a precoder and a transmission rank to be applied to PUSCH transmission, based on an SRI indicated by a BS. An SRI may be indicated through an SRS resource indicator, which is a field in DCI, or may be configured through srs-ResourceIndicator of higher layer signaling (e.g., RRC message). Similar to codebook-based PUSCH transmission described above, when an SRI is indicated to a terminal through DCI, an SRS resource indicated by the SRI may indicate an SRS resource corresponding to the SRI among SRS resources transmitted before a PDCCH including the indicated SRI. A terminal may use one or multiple SRS resources for SRS transmission, and a maximum number of SRS resources, which are jointly transmittable in the same symbol, in one SRS resource set may be determined by a terminal capability report transmitted by the terminal to a BS. SRS resources that a terminal is able to jointly transmit may include the same RBs. A terminal may configure one SRS port for each SRS resource. Only one SRS resource set may be configured as an SRS resource set for which the nonCodebook is configured as the value of usage in an SRS-ResourceSet of higher layer signaling (e.g., RRC message), and a maximum of four SRS resources for non-codebook-based PUSCH transmission may be configured.

A BS may transmit one NZP CSI-RS associated with an SRS resource set to a terminal, and the terminal may calculate a precoder to be used at the time of transmission of one or multiple SRS resources in the SRS resource set, based on a result of measurement performed at the time of reception of the NZP CSI-RS. The terminal may apply the calculated precoder when transmitting, to the BS, one or multiple SRS resources in an SRS resource set for which the nonCodebook is configured as usage, and the BS may select one or multiple SRS resources among the one or multiple SRS resources received from the terminal. In non-codebook-based PUSCH transmission, an SRI may indicate an index which is able to represent one or a combination of multiple SRS resources, and the SRI may be included in DCI. The number of SRS resource indicated by an SRI transmitted by a BS may be the number of PUSCH transmission layers, and a terminal may apply a precoder applied to SRS resource transmission to each of the layers to transmit the PUSCH.

A 5G system may support PUSCH repetitive transmission type A and PUSCH repetitive transmission type B for UL data channels, and TB processing over multi-slot PUSCH (TBoMS) for transmitting a TB through multiple PUSCHs over multiple slots. In addition, a BS may configure, for a terminal, one of PUSCH repetitive transmission type A or B through higher layer signaling (e.g., RRC message). and may configure numberOfSlotsTBoMS through a resource allocation table. The terminal may transmit TBoMS through the configured resource allocation table.

PUSCH Repetitive Transmission Type A

The starting symbol and the length of a UL data channel may be determined by a method of time domain resource allocation in one slot, and the BS may transmit the number of times of repetitive transmission to the terminal through higher layer signaling (e.g., RRC signaling) or L1 signaling (e.g., DCI). The number N of slots configured by numberOfSlotsTBoMS for TBS determination may be 1.

The terminal may repeatedly transmit, in consecutive slots, a UL data channel having the same starting symbol and the same length as the UL data channel configured by the BS, based on the number of times of repetitive transmission received from the BS. When at least one symbol among symbols of a slot configured as a DL by the BS for the terminal or a slot for repetitive transmission of a UL data channel is configured as a DL, the terminal may omit UL data channel transmission in the slot configured as the DL by the BS for the terminal or the slot for repetitive transmission of the UL data channel. For example, the terminal may not transmit a UL data channel within the number of times of repetitive transmission of the UL data channel. However, a terminal supporting 3GPP release 17 (Rel-17) UL data repetitive transmission may determine, as an available slot, a slot in which UL data repetitive transmission is possible, and the number of times of transmission may be counted when the UL data channel is repeatedly transmitted in the slot determined as the available slot. When repetitive transmission of a UL data channel is omitted in the slot determined as the available slot, repetitive transmission of the UL data channel may be postponed, and then the UL data channel may be repeatedly transmitted in a slot in which transmission is possible. In Table 12 below, a redundancy version may be applied according to a redundancy version pattern configured every n-th PUSCH transmission occasion.

PUSCH Repetitive Transmission Type B

The starting symbol and the length of the UL data channel may be determined by a method of time domain resource allocation in one slot, and the BS may transmit numberofrepetitions, which is the number of times of repetitive transmission, to the terminal through higher layer signaling (e.g., RRC signaling) or L1 signaling (e.g., DCI). The number N of slots configured by numberOfSlotsTBoMS for TBS determination may be 1.

A nominal repetition of a UL data channel may be determined as below based on the starting symbol and the length of the UL data channel configured above by the BS. The nominal repetition may indicate a resource of a symbol configured for PUSCH repetitive transmission by the BS, and the terminal may determine a resource usable as UL in the configured nominal repetition. In this case, a slot in which the n-th nominal repetition starts may be given by

$${K}_{s} + [ \frac{S + n \cdot L}{{N}_{s y m b}^{slot}} ] ,$$

and a symbol in which the nominal repetition starts in the starting slot may be given by mod(S+n·L,N_{symb}^{slot}). A slot in which the n-th nominal repetition ends may be given by

$${K}_{s} + [ \frac{S + ( n + 1 ) \cdot L - 1 )}{{N}_{s y m b}^{slot}} ] ,$$

and a symbol in which the nominal repetition ends in the last slot may be given by mod(S+(n+1)·L−1, N_{symb}^{slot}). Herein, n=0, . . . , numberofrepetitions−1, S may denote the starting symbol of the UL data channel configured by the BS, and L may denotes the symbol length of the UL data channel configured by the BS. KS may indicate a slot in which PUSCH transmission starts, and N_{symb}^{slot} may indicate the number of symbols per slot.

The terminal may determine an invalid symbol for PUSCH repetitive transmission type B. A symbol configured as a DL by tdd-UL-DL-ConfigurationCommon or tdd-UL-DL-ConfigurationDedicated may be determined as an invalid symbol for PUSCH repetitive transmission type B. Additionally, an invalid symbol may be configured based on a higher layer parameter (e.g., InvalidSymbolPattern) providing a symbol level bitmap over one slot or two slots. In an embodiment, 1 in a bitmap may indicate an invalid symbol and the period and the pattern of a bitmap may be configured through a higher layer parameter (e.g., periodicityAndPattern). If a higher layer parameter (e.g., InvalidSymbolPattern) is configured, and the parameter InvalidSymbolPatternIndicator-ForDCIFormat0_1 or InvalidSymbolPatternIndicator-ForDCIFormat0_2 is 1, the terminal may apply an invalid symbol pattern. If a higher layer parameter (e.g., InvalidSymbolPattern) is configured, and the parameter InvalidSymbolPatternIndicator-ForDCIFormat0_1 or InvalidSymbolPatternIndicator-ForDCIFormat0_2 represents 0, the terminal may not apply an invalid symbol pattern. Alternatively, if a higher layer parameter (e.g., InvalidSymbolPattern) is configured, and the parameter InvalidSymbolPatternIndicator-ForDCIFormat0_1 or InvalidSymbolPatternIndicator-ForDCIFormat0_2 is not configured, the terminal may apply an invalid symbol pattern.

After an invalid symbol is determined in each nominal repetition, the terminal may consider, as valid symbols, symbols except for the determined invalid symbol. If one or more valid symbols are included in each nominal repetition, the nominal repetition may include one or more actual repetitions. Each actual repetition may indicate symbols actually used for PUSCH repetitive transmission among symbols configured as a nominal repetition, and may include a set of consecutive valid symbols that are available for PUSCH repetitive type B in one slot. Other than when the symbol length L of the UL data channel configured by the BS is equal to 1, when an actual repetition having one symbol is configured to be valid, the terminal may omit actual repetition transmission. In Table 12 below, a redundancy version may be applied according to a redundancy version pattern configured every n-th actual repetition.

TB processing over multiple slots (TBoMS) The starting symbol and the length of a UL data channel may be determined by a method of time domain resource allocation in one slot, and the BS may transmit the number of times of repetitive transmission to the terminal through higher layer signaling (e.g., RRC signaling) or L1 signaling (e.g., DCI). A TBS may be determined using an N value (e.g., N is greater than or equal to 1) which is the number of slots configured by numberOfSlotsTBoMS.

The terminal may transmit, in consecutive slots and to the BS, a UL data channel having the same starting symbol and the same length as the UL data channel configured by the BS, based on the number of times of repetitive transmission and the number of slots for TBS determination, which are received from the BS. When at least one symbol among symbols of a slot configured as DL by the BS for the terminal or a slot for repetitive transmission of a UL data channel configured by the BS is configured as DL, the terminal may omit UL data channel transmission in the slot configured as a DL by the BS for the terminal or the slot for repetitive transmission of the UL data channel configured by the BS. For example, the terminal may not transmit, to the BS, an UL data channel included in the number of times of repetitive transmission of the UL data channel.

A terminal supporting Rel-17 UL data repetitive transmission may determine, as an available slot, a slot in which UL data repetitive transmission is possible, and the number of times of transmission may be counted when a UL data channel is repeatedly transmitted in the slot determined as the available slot. When repetitive transmission of the UL data channel is omitted in the slot determined as the available slot, the terminal may postpone repetitive transmission of the UL data channel, and then repeatedly transmit the UL data channel to the BS in a slot in which transmission is possible. In Table 12 below, a redundancy version may be applied according to a redundancy version pattern configured every n-th PUSCH transmission occasion.

TABLE 12

| | r_{Vid} to be applied to n^{th} transmission | | | |
|---|---|---|---|---|
| | occasion (repetition Type A) or TB | | | |
| r_{Vid} | processing over multiple slots) or n^{th} | | | |
| indicated | actual repetition (repetition Type B) | | | |
| by the DCI | ((n-(n mod | ((n-(n mod | ((n-(n mod | ((n-(n mod |
| scheduling | N))/N) | N))/N) | N))/N) | N))/N) |
| the | mod | mod | mod | mod |
| PUSCH | 4 = 0 | 4 = 0 | 4 = 0 | 4 = 0 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

When AvailableSlotCounting being enabled is configured for a terminal, the terminal may determine an available slot, based on tdd-UL-DL-ConfigurationCommon, tdd-UL-DL-ConfigurationDedicated, ssb-PositionsInBurst, and a time domain resource allocation (TDRA) information field value for type A PUSCH repetitive transmission and TBoMS PUSCH transmission. When at least one symbol configured by TDRA for a PUSCH in a slot for PUSCH transmission overlaps with at least one symbol for a purpose other than UL transmission, the slot for PUSCH transmission may be determined as an unavailable slot.

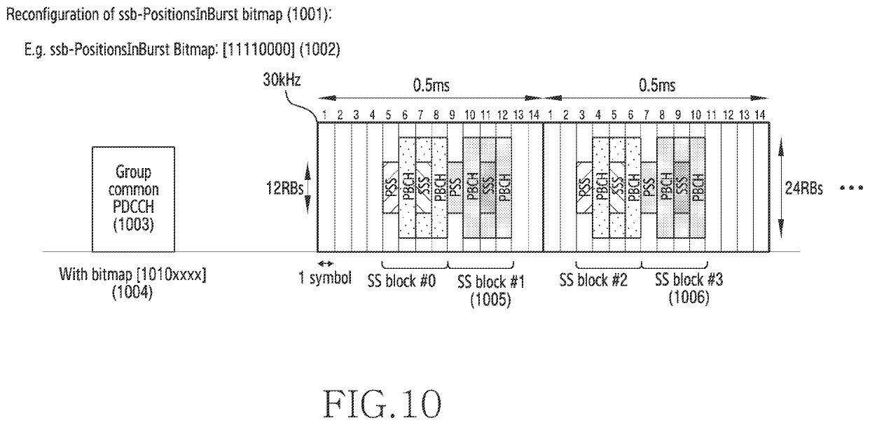

FIG. 10 illustrates a method of reconfiguring SSB transmission through dynamic signaling of a 5G system according to an embodiment of the disclosure.

Referring to FIG. 10, a BS may configure, for a terminal, ssb-PositionsInBurst=11110000 1002 through higher layer signaling (e.g., SIB1 or ServingCellConfigCommon), and a maximum of two SSBs at a subcarrier spacing of 30 kHz may be transmitted within a time of 0.5 ms, which corresponds to one slot length when one slot is configured by 14 OFDM symbols. Therefore, the terminal may receive four SSBs in a time of 1 ms (or this corresponds to two-slot length when one slot is configured by 14 OFDM symbols). The BS may reduce the density of SSB transmission to save energy. In order to reduce the density of SSB transmission, the BS may reconfigure SSB transmission configuration information by broadcasting bitmap 1010xxxx 1004 through group common DCI 1003 having a network energy saving-radio network temporary identifier (nwes-RNTI) (or es-RNTI). The terminal may cancel transmission of SS block #1 1005 and SSblock #3 1006, based on the bitmap 1004 configured through group common DCI. FIG. 10 illustrates a method 1001 of reconfiguring SSB transmission through group common DCI based on a bitmap.

In addition, the BS may reconfigure ssb-periodicity configured by higher layer signaling (e.g., RRC message), through group common DCI. The BS may additionally configure timer information for indicating a time point of applying group common DCI, and may transmit an SSB, based on SSB transmission information reconfigured by the group common DCI for the time of a configured timer. After the timer is ended, the BS may transmit an SSB, based on SSB transmission information configured by previous higher layer signaling (e.g., RRC message).

The BS may change a configuration from a normal mode to an energy saving mode by using a timer, and reconfigure SSB configuration information according to the configuration change. The BS may configure, for the terminal, a time point and a period of application of SSB configuration information reconfigured using group common DCI, by using offset and interval information. The terminal may not monitor an SSB for a configured interval from a moment (e.g., a time point at which an offset is applied) when group common DCI is received.

A BS may reconfigure reference signal configuration information through higher layer signaling and dynamic signaling to reduce energy consumption. In this case, a method of determining, when a reference signal for measuring downlink path loss is canceled, a reference signal for measuring downlink path loss by a terminal is disclosed.

### First Embodiment: PUSCH Power Control Method

In this method, when a terminal transmits UL data through an UL data channel in response to a power control command received from a BS, the terminal configures the transmission power of the UL data channel and transmits the UL data. UL data channel transmission power of the terminal may be determined as shown below in Equation (2) with a PUSCH power control adjustment state corresponding to the i-th transmission unit, parameter set configuration index j, and closed loop index 1. In Equation (2), when the terminal supports multiple carrier frequencies in multiple cells, each parameter may be determined by cell c, carrier frequency f, and BWP b, and may be distinguished by the indexes b, f, and c.

$${P}_{PUSCH , b , f , c} ( i , j , {q}_{d} , l ) = min \{ \begin{matrix}{P}_{CMAX , f , c} ( i ) , \\ \begin{matrix}{P}_{{0}_{P U S C H} , b , f , c} ( j ) + 10 {log}_{10} ( {2}^{μ} \cdot {M}_{RB , b , f , c}^{P U S C H} ( i ) ) + \\ {a}_{b , f , c} ( j ) \cdot {PL}_{b , f , c} ( {q}_{d} ) + {Δ}_{T F , b , f , c} ( i ) + {f}_{b , f , c} ( i , l )\end{matrix}\end{matrix} \} [ dBm ] \qquad ( 2 )$$

In Equation (2), P_{CMAX,f,c}(i) is the maximum transmission power that the terminal is able to use in the i-th transmission unit, and may be determined by the power class of the terminal, and parameters activated by the BS and various parameter embedded in the terminal.

P_{0_PUSCH,b,f,c}(j) may be configured by the sum of P_{0_NOMINAL_PUSCH,f,c}(j) and P_{0_UE_PUSCH,b,f,c}(j). P_{0_NOMINAL_PUSCH,f,c}(j) may be configured for the terminal through cell-specific higher layer signaling, and P_{0_UE_PUSCH,b,f,c}(j) may be configured through terminal-specific higher layer signaling. P_{0_PUSCH,b,f,c}(j) may indicate a PUSCH for transmitting msg3 when j=0, indicate a configured grant PUSCH when j=1, and indicate a grant PUSCH when j is one value of j={2, . . . , J−1}.

μ: Subcarrier spacing configuration value

M_{RB,b,f,c}^{PUSCH}(i) may indicate a resource amount (e.g., the number of RBs used for PUSCH transmission in the frequency domain) used in the i-th PUSCH transmission unit.

a_{b,f,c}(j) is a value for compensating for path loss, and may indicate a value that may be determined through a higher layer configuration and an SRS resource indicator (SRI) (in a dynamic grant PUSCH).

PL_{b,f,c}(q_{d}) is path loss between the BS and the terminal, and the terminal may calculate path loss from the difference between the transmission power of the reference signal resource q_{d} signaled by the BS and the terminal reception signal level of a reference signal. PL_{b,f,c}(q_{d}) may indicate a DL path loss estimation estimated by the terminal through a reference signal having a reference signal index of q_{d}, and the reference signal index ad may be determined by the terminal through a higher layer configuration and an SRI (e.g., in a dynamic grant PUSCH or a configured grant PUSCH (type 2 configured grant PUSCH) based on ConfiguredGrantConfig not including the higher layer configuration rrc-ConfiguredUplinkGrant) or a higher layer configuration.

Δ_{TF,b,f,c}(i) may indicate a value determined according to a modulation coding scheme (MCS) and a format (transport format (TF)) of information transmitted through a PUSCH (e.g., whether UL-SCH is included or whether CSI is included).

f_{b,f,c}(i,l) is a closed loop power control adjustment value, and may indicate the value of closed loop index 1 which may be determined for a PUSCH by a higher layer configuration and an SRI. Closed loop power adjustment for PUSCH transmission may be supported by an accumulation method of accumulating and applying a value indicated by a TPC command, or an absolute method of directly applying a value indicated by a TPC command, and may be determined according to whether the higher layer parameter tpc-Accumulation is configured. When the higher layer parameter tpc-Accumulation is configured to be disabled, closed loop power adjustment for PUSCH transmission may be performed by the absolute method, and when tpc-Accumulation is not configured, closed loop power adjustment for PUSCH transmission may be performed by the accumulation method.

More specifically, the terminal may determine the reference signal index q_{d} of P_{Lb,f,c}(a) according to the following conditions.

When PUSCH-PathlossReferenceRS and enabledDefaultBeamPL-ForSRS are not configured for the terminal or before a dedicated higher layer parameter is configured for the terminal, the terminal may calculate PL_{b,f,c}(q_{d}) by using, as an RS resource, an SS/PBCH block having the same SS/PBCH block index as that used to receive an MIB.

When the number of RS resource indexes are configured for the terminal up to the value of maxNrofPUSCH-PathlossReferenceRSs, and each RS configuration set is configured according to the number of RS resource indexes by PUSCH-PathlossReferenceRS, the terminal may identify the RS resource index q_{d} in an RS resource index set corresponding to an SS/PBCH block index or a CSI-RS resource index provided by pusch-PathlossReferenceRS-Id of PUSCH-PathlossReferenceRS. In this case, an RS resource set may include one or two SS/PBCH block index sets when a PUSCH-PathlossReferenceRS-Id value is mapped to an SS/PBCH block index, and a CSI-RS resource index set when a pusch-PathlossReferenceRS-Id value is mapped to a CSI-RS resource index.

When a PUSCH is scheduled by a random access response (RAR) UL grant or Type-2 random access procedure, the terminal may use the same RS resource index q_{d} as a physical random access channel (PRACH) transmission.

When SRI-PUSCH-PowerControl and one or more values of PUSCH-PathlossReferenceRS-Id are configured for the terminal, the terminal may receive mapping information between an SRI field value and PUSCH-PathlossReferenceRS-Id from the BS through sri-PUSCH-PowerControlId of SRI-PUSCH-PowerControl between a set of values for an SRI field in a DCI format scheduling PUSCH transmission and PUSCH-PathlossReferenceRS-Id values, and determine the RS resource index q_{d} from PUSCH-PathlossReferenceRS-Id mapped to the SRI field value.

When PUSCH transmission is scheduled by DCI format 0_0 and spatial configuration is performed for the terminal by PUCCH-SpatialRelationInfo, the terminal may use the same RS resource index q_{d} as PUCCH transmission using a PUCCH resource having the lowest index.

When PUSCH transmission is not scheduled by DCI format 0_0, enableDefaultBeamPL-ForSRS is configured for the terminal, and PUSCH-PathlossReferenceRS and PUSCH-PathlossReferenceRS-r16 are not configured, the terminal may use the same RS resource index a as an SRS resource set including SRS resources related to PUSCH transmission.

When PUSCH transmission is scheduled by DCI format 0_0, and a spatial configuration for PUCCH transmission is not provided to the terminal, a PUSCH is scheduled by DCI format 0_1 or DCI format 0_2 not including an SRI field, or SRI-PUSCH-PowerControl is not configured for the terminal, the terminal may determine the RS resource index q_{d} having a PUSCH-PathlossReferenceRS-Id value of 0.

When PUSCH transmission is scheduled by DCI format 0_0, a PUCCH resource is not configured for the terminal, and enableDefaultBeamPL-ForPUSCH0-0 is configured for the terminal, the terminal may use, as the RS resource index q_{d}, a periodic RS resource configured by qcl-Type of typeD in a TCI state or QCL assumption of a control resource set (CORESET) having the lowest index.

When PUSCH transmission is scheduled by DCI format 0_0, a spatial configuration for PUCCH resources is not provided to the terminal, and enabledDefaultBeamPL-ForPUSCH0_0 is configured for the terminal, the terminal may use, as the RS resource index q_{d}, a periodic RS resource configured by qcl-Type of typeD in a TCI state or QCL assumption of a CORESET having the lowest index.

For PUSCH transmission configured by ConfiguredGrantConfig, when rrc-ConfiguredUplinkGrant is included in ConfiguredGrantConfig, the RS resource index q_{d} may be determined by a pathlossReferenceIndex value included in rrc-ConfiguredUplinkGrant.

For PUSCH transmission configured by ConfiguredGrantConfig not including rrc-ConfiguredUplinkGrant, the terminal may determine the RS resource index q_{d} by PUSCH-PathlossReferenceRS-Id mapped to an SRI field in a DCI format activating PUSCH transmission. If DCI activating a PUSCH transmission does not include an SRI field, the terminal may determine the RS resource index q_{d} as an RS resource index having a PUSCH-PathlossReferenceRS-Id value of 0.

When enablePL-RS-UpdateForPUSCH-SRS is configured for the terminal, and mapping between sri-PUCCH-PowerControlId and PUSCH-PathlossReferenceRS-Id is updated by a MAC CE, for PUSCH transmission scheduled by a DCI format not including an SRI field, PUSCH transmission configured by ConfiguredGrantConfig, or a PUSCH activated by a DCI format that is described in the standard and does not include an SRI field, the RS resource index q_{d} may be determined by PUSCH-PathlossReferenceRS-Id mapped to sri-PUSCH-PowerControlId=0.

Through the above method, a terminal may determine an RS resource for measuring path loss (PL), based on higher layer signaling and L1 signaling, or a spatial configuration for a PUCCH so as to determine power for PUSCH transmission.

The first embodiment of the disclosure provides methods of determining an RS resource of a terminal according to change of RS resource transmission configuration information for energy saving. In addition, restrictions on change of RS resource transmission configuration information for energy saving of a BS are disclosed. An RS resource determination method for measuring downlink PL may be one or a combination of the following methods.

Method 1-1

In method 1-1, a method in which a BS may change, for a terminal, pre-configured SSB and CSI-RS configuration information through higher layer signaling (e.g., RRC message) and L1 signaling (e.g., DCI) for energy saving, and determines an RS resource for a PL-RS of the terminal is proposed. Pre-configured SSB and CSI-RS configuration information may be reconfigured for a terminal through higher layer signaling (e.g., RRC message) and L1 signaling (e.g., DCI) for energy saving from a BS, and the terminal may determine an RS resource according to whether a new RS resource for a PL-RS is configured, as in the following methods.

Method 1-2

A BS may reconfigure, for a terminal, pre-configured SSB and CSI-RS configuration information through higher layer signaling (e.g., RRC message) and L1 signaling (e.g., DCI) for energy saving, and may configure a new RS resource for a PL-RS therefor. The terminal does not apply a conventional method of determining a PL-RS, and may apply a new RS resource configured by the BS to measure a DL path loss and determine PUSCH transmission power. As a method of configuring a new RS resource for a PL-RS, an SSB index and a CSI-RS index may be pre-configured through higher layer signaling (e.g., RRC message), or may be configured through L1 signaling (e.g., a DCI format for energy saving). Thereafter, the BS may perform beam management, based on the SSB index and CSI-RS index which are reconfigured according to an embodiment. This method may also be applied to measure a DL path loss value for a PUSCH configured through ConfiguredGrantConfig, and an RS resource for a PUSCH configured through ConfiguredGrantConfig for energy saving may be configured in rrc-ConfiguredUplinkGrant or ConfiguredGrantConfig.

Method 1-3

A BS may reconfigure, for a terminal, pre-configured SSB and CSI-RS configuration information through higher layer signaling (e.g., RRC message) and L1 signaling (e.g., DCI) for energy saving, and may not configure a new RS resource for a PL-RS therefor. The terminal may determine a PL-RS as in the following methods according to whether there is a pre-configured RS resource for energy saving.

Method 1-4

When a BS reconfigures, for a terminal, pre-configured SSB and CSI-RS configuration information through higher layer signaling (e.g., RRC message) and L1 signaling (e.g., DCI) for energy saving, an RS resource having been used as a PL-RS may be canceled based on the reconfigured SSB and CSI-RS transmission information. When RS resources for energy saving are configured for the terminal in advance through higher layer signaling (e.g., RRC message), the terminal may identify RS resource indexes overlapping (or mapped) between the RS resources configured for energy saving and PUSCH-PathlossReferenceRS, SRI-PUSCH-PowerControl, PUCCH-spatialRelationInfo, or rrc-ConfiguredUplinkGrant in ConfiguredGrantConfig, which is previously configured, and may use the identified RS resource indexes as a PL-RS.

Method 1-5

When a BS reconfigures, for a terminal, pre-configured SSB and CSI-RS configuration information through higher layer signaling (e.g., RRC message) and L1 signaling (e.g., DCI) for energy saving, an RS resource having been used as a PL-RS may be canceled based on the reconfigured SSB and CSI-RS transmission information. When RS resources for energy saving are configured for the terminal in advance through higher layer signaling (e.g., RRC signaling) and there are no RS resource indexes overlapping (or mapped) between the RS resources configured for energy saving and PUSCH-PathlossReferenceRS, SRI-PUSCH-PowerControl, PUCCH-spatialRelationInfo, or rrc-ConfiguredUplinkGrant in ConfiguredGrantConfig, which is previously configured, the terminal may determine, as a PL-RS, one of the RS resources configured in advance for energy saving or an RS resource having the lowest index.

Method 1-6

When a BS reconfigures, for a terminal, pre-configured SSB and CSI-RS configuration information through higher layer signaling (e.g., RRC message) and L1 signaling (e.g., DCI) for energy saving, an RS resource having been used as a PL-RS may be canceled based on the reconfigured SSB and CSI-RS transmission information. If RS resources for energy saving are not configured for the terminal in advance through higher layer signaling (e.g., RRC message), the terminal may determine a PL-RS according to an RS resource having the lowest index among RS resources which have not been canceled among candidate RS resources previously configured according to PUSCH-PathlossReferenceRS, SRI-PUSCH-PowerControl, PUCCH-spatialRelationInfo, or rrc-ConfiguredUplinkGrant in ConfiguredGrantConfig.

Method 1-7

When a BS reconfigures, for a terminal, pre-configured SSB and CSI-RS configuration information through higher layer signaling (e.g., RRC message) and L1 signaling (e.g., DCI) for energy saving, an RS resource having been used as a PL-RS may be canceled based on the reconfigured SSB and CSI-RS transmission information. When RS resources for energy saving are not configured for the terminal in advance through higher layer signaling (e.g., RRC message) and previously configured RS resources are all canceled, the terminal may use, as a PL-RS, an SSB having been used to receive an MIB, or may continuously apply a DL path loss measured using an existing PL-RS until an operation is reconfigured from an operation for energy saving to a normal operation. If DL path loss measurement is not performed for a predetermined period, the terminal may perform handover.

Through the above methods, when an RS resource used as a PL-RS is canceled by RS resource reconfiguration for energy saving, a terminal may determine an RS resource for a PL-RS and determine power for PUSCH transmission. Configuration by a BS may be applied and limited to a mode for energy saving. In addition, when a BS changes or configures a mode from an energy saving mode to a normal mode, a terminal may recycle an existing configuration to determine an RS resource for a PL-RS. Through the above methods, a terminal may determine a PL-RS while a BS does not transmit RS resources or transmits reduced RS resources for energy saving.

Method 2-1

In method 2-1, limitations on a BS for cell operation when the BS changes, for a terminal, pre-configured SSB and CSI-RS configuration information through higher layer signaling (e.g., RRC message) and L1 signaling (e.g., DCI) for energy saving are proposed. A BS may reconfigure a reference signal by considering limitations through one of the following methods or a combination thereof.

Method 2-2

A BS may determine cancelable SSBs to reduce the number of times of SSB transmission or cancel transmission and adjust a period. More specifically, a BS may cancel an SSB other than an SSB used by a terminal in initial access. Therefore, the terminal may not consider that an SSB used in initial access is canceled.

Method 2-3

A BS may determine a cancelable SSB to reduce the number of times of SSB transmission or cancel transmission and adjust a period. More specifically, in order to cancel an SSB, if there is a CSI-RS, the qcl-type of which is configured as TypeD, the SSB is replaceable with the CSI-RS, and thus the BS may cancel the SSB.

Method 2-4

A BS may determine a cancelable CSI-RS to reduce the number of times of CSI-RS transmission or cancel transmission and adjust a period. More specifically, in order to cancel a CSI-RS, if there is an SSB, the qcl-type of which is configured as TypeD, the CSI-RS is replaceable with the SSB, and thus the BS may cancel the CSI-RS. In addition, the BS may cancel only a CSI-RS having at least one port, which is used to measure L1-reference signal received power (RSRP) and L1-reference signal received quality (RSRQ) for DL path loss and beam management.

Based on the above methods, a BS may determine cancelable reference signals. The above methods may be used for a terminal to determine a reference signal that is not always canceled. Through the above methods, a minimum function for cell operation may be provided and complexity may be reduced. However, excessive energy may be consumed.

### Second Embodiment: PUCCH Power Control Method

In this method, when a terminal transmits UL control information through a UL control channel in response to a power control command received from a BS, the terminal configures the transmission power of the UL control channel and transmits the control information. UL control channel transmission power (PPUCCH) of the terminal may be determined as Equation (3) below expressed by a unit of dBm together with a PUCCH power control adjustment state corresponding to the i-th transmission unit and closed loop index 1. In Equation 3 below, when the terminal supports multiple carrier frequencies in multiple cells, each parameter may be determined by primary cell c, carrier frequency f, and bandwidth part b, and may be distinguished by the indexes b, f, and c.

$${P}_{PUCCH , b , f , c} ( i , {q}_{u} , {q}_{d} , l ) = min \{ \begin{matrix}{P}_{CMAX , f , c} ( i ) , \\ \begin{matrix}{P}_{{0}_{PUCCH} , b , f , c} ( {q}_{u} ) + 10 {log}_{10} ( {2}^{μ} \cdot {M}_{RB , b , f , c}^{PUCCH} ( i ) ) + \\ {PL}_{b , f , c} ( {q}_{d} ) + {Δ}_{{F}_{PUCCH}} ( F ) + {Δ}_{TF , b , f , c} ( i ) + {f}_{b , f , c} ( i , l )\end{matrix}\end{matrix} \} [ dBm ] \qquad ( 3 )$$

In Equation (3), P_{CMAX,f,c}(i) is maximum transmission power that the terminal is able to use in the i-th transmission unit, and may be determined by the power class of the terminal, and parameters activated by the BS and various parameter embedded in the terminal.

P_{0_PUCCH,b,f,c}(qᵤ) may be configured by the sum of P_{0_NOMINAL_PUCCH} and P_{0_UE_PUCCH}(qᵤ). P_{0_NOMINAL_PUCCH} is a cell-specific value and may be configured through p0-nominal that is cell-specific higher layer signaling, and if there is no corresponding configuration, P_{0_NOMINAL_PUCCH} may be 0 decibel milliwatts (dBm). P_{0_UE_PUCCH}(qᵤ) is a cell-specific value and may be configured by p0-PUCCH-Value in p0-PUCCH, which is higher layer signaling, at bandwidth part b, carrier frequency f, and primary cell c, qᵤ may be greater than or equal to 0 and less than Qᵤ, and Qᵤ may indicate the size of a set of P_{0_UE_PUCCH} values and may be configured by maxNrofPUCCH-P0-PerSet which is higher layer signaling. The set of P_{0_UE_PUCCH} values may be configured by p0-Set which is higher layer signaling, and if there is no corresponding configuration, the set may be considered as P_{OUEPUCCH}(qᵤ)=0.

μ: Subcarrier spacing configuration value

M_{RB,b,f,c}^{PUCCH}(i) may indicate a resource amount (e.g., the number of RBs used for PUCCH transmission in the frequency domain) used in the i-th PUCCH transmission unit in bandwidth part b, carrier frequency f, and primary cell c.

PL_{b,f,c}(q_{d}) is path loss between the BS and the terminal, and the terminal may calculate path loss from the difference between the transmission power of the reference signal resource a configured by the BS and the terminal reception signal level of a reference signal.

As to Δ_{F_PUCCH}(F), the terminal may use a corresponding value if a higher layer signaling of deltaF-PUCCH-f0 is configured for PUCCH format 0, use a corresponding value if a higher layer signaling of deltaF-PUCCH-f1 is configured for PUCCH format 1, use a corresponding value if a higher layer signaling of deltaF-PUCCH-f2 is configured for PUCCH format 2, use a corresponding value if a higher layer signaling of deltaF-PUCCH-f3 is configured for PUCCH format 3, use a corresponding value if a higher layer signaling of deltaF-PUCCH-f4 is configured for PUCCH format 4, and use 0 if a higher layer signaling is configured for all PUCCH formats.

Δ_{TF,b,f,c}(i) is a PUCCH transmission power adjustment element in bandwidth part b, carrier frequency f, and primary cell c, and different calculation methods may be used according to a PUCCH format.

q_{b,f,c}(i, l) may indicate a PUCCH power control adjustment state value for the i-th PUCCH transmission unit corresponding to closed loop index 1 in bandwidth part b, carrier frequency f, and primary cell c. Closed loop power adjustment for PUCCH transmission may employ an accumulation method of accumulating and applying a value indicated by a TPC command.

More specifically, the terminal may determine the reference signal index q_{d} of PL_{b,f,c}(q_{d}) according to the following conditions.

PL_{b,f,c} (q_{d}) may indicate a downlink path loss estimation calculated by the terminal for the RS resource index q_{d}.

If pathlossReferenceRSs or a terminal-specific higher layer parameter is not configured for the terminal, the terminal may calculate PL_{b,f,c}(q_{d}) by using an SS/PBCH block used to receive an MIB.

If the number of RS resource indexes is configured for the terminal, the terminal may calculate RS resources by using q_{d} of PL_{b,f,c}(q_{d}). In this case, an RS resource set may be provided by pathlossReferenceRSs. The RS resource set may include one or two sets among an SS/PBCH block index set provided by ssb-Index in PUCCH-PathlossReferenceRS when a corresponding pucch-PathLossReferenceRS-Id is mapped to an SS/PBCH block index, and a CSI-RS resource index set provided by csi-RS-Index when a corresponding pucch-PathLossReferenceRS-Id is mapped to a CSI-RS resource index. A UE may identify RS resources in an RS resource set corresponding to SS/PBCH block indexes or CSI-RS resource indexes provided by pucch-PathlossReferenceRS-Id in PUCCH-PathlossReferenceRS.

If the RS resource index q_{d} is configured for the terminal, the terminal may calculate PL_{b,f,c}(q_{d}) by using an RS resource having the index q_{d}. In this case, an RS resource set may be configured by pathlossReferenceRSs, and the RS resource set may include an SS/PBCH block index indicable by ssb-Index or a CSI-RS resource index indicable by csi-RS-Index. If the higher layer parameters pathlossReferenceRSs and PUCCH-SpatialRelationInfo are configured for the terminal, the terminal may determine PL_{b,f,c}(q_{d}) according to referenceSignal of PUCCH-PathlossReferenceRS, which corresponds to pucch-PathlossReferenceRS-Id configured in PUCCH-SpatialRelationInfo. In this case, if two or more values of PUCCH-SpatialRelationInfo may be configured, and a PUCCH including hybrid automatic repeat request acknowledgement (HARQ-ACK) information for a PDSCH providing an activation command for PUCCH-SpatialRelationInfo is transmittable in a k-th slot, the terminal may apply the activation command from the first slot after a (k+3)-th slot. If PUCCH-SpatialRelationInfo includes servingCellId, the terminal may receive an RS of the resource index q_{d} in an activated downlink BWP of a corresponding supported cell.

If PUCCH-SpatialRelationInfo includes servingCellId, the terminal may receive the RS resource index q_{d}.

If pathlossReferenceRSs is configured for the terminal and PUCCH-SpatialRelationInfo is not configured, the terminal may determine PL_{b,f,c}(q_{d}) according to referenceSignal of PUCCH-PathlossReferenceRS, the index of pucch-PathlossReferenceRS-Id is 0 among RS resources for a primary cell or (if configured) a supported cell indicated by the higher layer parameter pathlossReferenceLinking.

If a higher layer parameter is configured for the terminal as described below pathlossReferenceRSs is not configured, PUCCH-SpatialRelationInfo is not configured, and the higher layer parameter enableDefualtBeamPL-ForPUCCH-r16 is configured, any of CORESETs are not configured to have CORESETPoolIndex of 1 or all CORESETs are configured to have CORESETPoolIndex of 1, and any codepoints in a DCI format are not mapped to two TCI states, the terminal may determine the RS resource index q_{d} for a periodic RS resource including QCL-TypeD in a TCI state or for QCL assumption of a CORESET having the lowest index in an activated downlink BWP of a primary cell. If PUCCH transmission in multiple slots is possible, the terminal may apply the same q_{d} to each slot to transmit a PUCCH.

Through the above methods, a terminal may determine an RS resource for measuring a PL, based on higher layer signaling (e.g., RRC message) and L1 signaling (e.g., DCI) in order to determine power for PUCCH transmission.

The second embodiment of the disclosure provides methods of determining an RS resource of a terminal according to change of RS resource transmission configuration information for energy saving. In addition, restrictions on change of RS resource transmission configuration information for energy saving of a BS are disclosed. An RS resource determination method for measuring PL, which is downlink path loss, may be used as one or a combination of the following methods.

Method 3-1

In method 3-1, a method of determining an RS resource for a PL-RS of a terminal according to change of, by a BS for the terminal, pre-configured SSB and CSI-RS configuration information through higher layer signaling (e.g., RRC message) and L1 signaling (e.g., DCI) for energy saving is disclosed. Pre-configured SSB and CSI-RS configuration information may be reconfigured for a terminal through higher layer signaling (e.g., RRC message) and L1 signaling (e.g., DCI) for energy saving from a BS, and an RS resource may be determined according to whether a new RS resource for a PL-RS is configured, as in the following methods.

Method 3-2

A BS may reconfigure, for a terminal, pre-configured SSB and CSI-RS configuration information through higher layer signaling (e.g., RRC message) and L1 signaling (e.g., DCI) for energy saving, and may configure a new RS resource for a PL-RS therefor. The terminal does not apply a conventional method of determining a PL-RS, and may apply a configured new RS resource to measure a DL path loss and determine PUCCH transmission power. As a method of configuring a new RS resource for a PL-RS, an SSB index and a CSI-RS index may be pre-configured through higher layer signaling (e.g., RRC message), or may be configured through L1 signaling (e.g., a DCI format for energy saving). Thereafter, the BS may perform beam management, based on the SSB index and CSI-RS index which are reconfigured according to an embodiment.

Method 3-3

A BS may reconfigure, for a terminal, pre-configured SSB and CSI-RS configuration information through higher layer signaling (e.g., RRC message) and L1 signaling (e.g., DCI) for energy saving, and may not configure a new RS resource for a PL-RS therefor. The terminal may determine a PL-RS as in the following methods according to whether there is a pre-configured RS resource for energy saving.

Method 3-4

When a BS reconfigures, for a terminal, pre-configured SSB and CSI-RS configuration information through higher layer signaling (e.g., RRC message) and L1 signaling (e.g., DCI) for energy saving, an RS resource having been used as a PL-RS may be canceled based on the reconfigured SSB and CSI-RS transmission information. If RS resources for energy saving are configured for the terminal in advance through higher layer signaling (e.g., RRC message), the terminal may identify RS resource indexes overlapping or mapped between the RS resources configured for energy saving and pathlossReferenceRSs, PUCCH-PathlossReferenceRS, or pucch-SpatialRelationInfoId, which is previously configured, and may use the identified RS resource indexes as a PL-RS.

Method 3-5

When a BS reconfigures, for a terminal, pre-configured SSB and CSI-RS configuration information through higher layer signaling (e.g., RRC message) and L1 signaling (e.g., DCI) for energy saving, an RS resource having been used as a PL-RS may be canceled based on the reconfigured SSB and CSI-RS transmission information. If RS resources for energy saving are configured for the terminal in advance through higher layer signaling (e.g., RRC message) and there are no RS resource indexes overlapping or mapped between the RS resources configured for energy saving and pathlossReferenceRSs, PUCCH-PathlossReferenceRS, or pucch-SpatialRelationInfoId, which is previously configured, the terminal may determine, as a PL-RS, one of the RS resources configured in advance for energy saving or an RS resource having the lowest index.

Method 3-6

When a BS reconfigures, for a terminal, pre-configured SSB and CSI-RS configuration information through higher layer signaling (e.g., RRC message) and L1 signaling (e.g., DCI) for energy saving, an RS resource having been used as a PL-RS may be canceled based on the reconfigured SSB and CSI-RS transmission information. If RS resources for energy saving are not configured for the terminal in advance through higher layer signaling, the terminal may determine a PL-RS according to an RS resource having the lowest index among RS resources which have not been canceled among candidate RS resources previously configured according to pathlossReferenceRSs, PUCCH-PathlossReferenceRS, or pucch-SpatialRelationInfoId.

Method 3-7

When a BS reconfigures, for a terminal, pre-configured SSB and CSI-RS configuration information through higher layer signaling (e.g., RRC message) and L1 signaling (e.g., DCI) for energy saving, an RS resource having been used as a PL-RS may be canceled based on the reconfigured SSB and CSI-RS transmission information. When RS resources for energy saving are not configured for the terminal in advance through higher layer signaling and all RS resources previously configured for the terminal are canceled, the terminal may use, as a PL-RS, an SSB having been used to receive an MIB, or may continuously apply DL a path loss measured using an existing PL-RS until an operation is reconfigured from an operation for energy saving to a normal operation. If DL pathloss measurement is not performed for a predetermined period, the terminal may perform handover.

Through the above methods, when an RS resource used as a PL-RS is canceled by RS resource reconfiguration configured by a BS for energy saving, a terminal may determine an RS resource for a PL-RS of the terminal and determine power for PUCCH transmission. Configuration from a BS may be applied and limited to a mode for energy saving. In addition, when a BS changes or configures a mode from an energy saving mode to a normal mode, a terminal may recycle an existing configuration to determine a resource for a PL-RS. Accordingly, a terminal may determine a PL-RS while a BS does not transmit RS resources or transmits reduced RS signals for energy saving.

Method 4-1

In method 4-1, limitations on a BS for cell operation when the BS changes, for a terminal, pre-configured SSB and CSI-RS configuration information through higher layer signaling (e.g., RRC message) and L1 signaling (e.g., DCI) for energy saving are proposed. A BS may reconfigure a reference signal by considering limitations through one of the following methods or a combination thereof.

Method 4-2

A BS may determine a cancelable SSB to reduce the number of times of SSB transmission or cancel transmission and adjust a period. More specifically, a BS may cancel an SSB other than an SSB used by a terminal in initial access. Therefore, the terminal may not consider that an SSB used in initial access is canceled.

Method 4-3

A BS may determine a cancelable SSB to reduce the number of times of SSB transmission or cancel transmission and adjust a period. More specifically, in order to cancel an SSB, if there is a CSI-RS, the qcl-type of which is configured as TypeD, the SSB is replaceable with the CSI-RS, and thus the BS may cancel the SSB.

Method 4-4

A BS may determine a cancelable CSI-RS to reduce the number of times of CSI-RS transmission or cancel transmission and adjust a period. More specifically, in order to cancel a CSI-RS, if there is an SSB, the qcl-type of which is configured as TypeD, the CSI-RS is replaceable with the SSB, and thus the BS may cancel the CSI-RS. In addition, the BS may cancel only a CSI-RS having one or two ports or more, which is used to measure L1-RSRP and L1-RSRQ for DL pathloss and beam management.

Based on the above methods, a BS may determine cancelable reference signals. The above methods may be used for a terminal to determine a reference signal that is not always canceled. Accordingly, a minimum function for cell operation may be provided and complexity may be reduced. However, excessive energy may be consumed.

### Third Embodiment: SRS Power Control Method

In this method, when a terminal performs transmission through an UL reference signal (sounding reference signal (SRS)) in response to a power control command received from a BS, the terminal configures the transmission power of the UL reference signal and transmits the signal. UL reference signal transmission power (PSRS) of the terminal may be determined in Equation (4) below expressed by a unit of dBm together with an SRS power control adjustment state corresponding to the i-th transmission unit and closed loop index 1. In Equation (4), when the terminal supports multiple carrier frequencies in multiple cells, each parameter may be determined by cell c, carrier frequency f, and bandwidth part b, and may be distinguished by the indexes b, f, and c.

$${P}_{SRS , b , f , c} ( i , {q}_{s} , l ) = min \{ \begin{matrix}{P}_{CMAX , f , c} ( i ) , \\ \begin{matrix}{P}_{0 \_ SRS , b , f , c} ( {q}_{s} ) + 10 {log}_{10} ( {2}^{μ} \cdot {M}_{SRS , b , f , c} ( i ) ) + \\ {a}_{SRS , b , f , c} ( {q}_{s} ) \cdot {PL}_{b , f , c} ( {q}_{d} ) + {h}_{b , f , c} ( i , l )\end{matrix}\end{matrix} \} [ dBm ] \qquad ( 4 )$$

In Equation (4), P_{CMAX,f,c}(i) is maximum transmission power that the terminal is able to use in the i-th transmission unit, and may be determined by the power class of the terminal, and parameters activated by the BS and various parameter embedded in the terminal.

P_{0_SRS,b,f,c}(qₛ) may be configured by p0, which is higher layer signaling, for bandwidth part b, carrier frequency f, and cell c, and the SRS resource set qₛ may be configured by SRS-ResourceSet and SRS-ResourceSetId, which are higher layer signaling.

μ: Subcarrier spacing configuration value

M_{SRS,b,f,c}(i) may indicate a resource amount (e.g., the number of RBs used for SRS transmission in the frequency axis) used in the i-th SRS transmission unit.

a_{SRS,b,f,c}(qₛ) may be configured by alpha, which is higher layer signaling, for bandwidth part b, carrier frequency f, and cell c, and the SRS resource set qₛ may be configured by SRS-ResourceSet and SRS-ResourceSetId, which are higher layer signaling.

PL_{b,f,c}(g) is path loss between the BS and the terminal, and the terminal may calculate path loss from the difference between the transmission power of the reference signal resource a signaled by the BS and the terminal reception signal level of a reference signal.

h_{b,f,c}(i, l) may indicate an SRS power control adjustment state value for the i-th SRS transmission unit corresponding to closed loop index 1 in bandwidth part b, carrier frequency f, and cell c.

More specifically, the terminal may determine the reference signal index q_{d} of PL_{b,f,c}(q_{d}) according to the following conditions.

If pathlossReferenceRSs or SRS-PathlossReferenceRS-Id is not configured for the terminal, or a terminal-specific higher layer parameter is not configured therefor, the terminal may calculate PL_{b,f,c} (q_{d}) by using an SS/PBCH block used to receive an MIB.

If pathlossReferenceRS or SRS-PathlossReferenceRS-Id is not configured for the terminal, spatialRelationInfo is not configured, enableDefaultBeamPL-ForSRS is configured, coresetPollIndex value 1 is not configured for any of CORESETs in ControlResourceSet or coresetPoolIndex values for all CORESETs are 1, and there is no codepoint of a TCI field in a DCI format of a search space set mapped to two TCI states, the terminal may determine, as the RS resource index q_{d}, a periodic RS resource which may be configured by qcl-Type of typeD in a TCI state or QCL assumption of a CORESET having the lowest index, and if CORESETs are not configured, is in an active PDSCH TCI state having the lowest index.

Through the above methods, a terminal may determine an RS resource for measuring a PL, based on higher layer signaling (e.g., RRC message) and L1 signaling (e.g., DCI) in order to determine power for SRS transmission.

The third embodiment of the disclosure provides methods of determining an RS resource of a terminal according to change of RS resource transmission configuration information for energy saving. In addition, restrictions on change of RS resource transmission configuration information for energy saving of a BS are disclosed. An RS resource determination method for measuring PL, which is downlink path loss, may be used as one of the following methods or a combination thereof.

Method 5-1

In method 5-1, a method of determining an RS resource for a PL-RS of a terminal according to change of, by a BS for the terminal, pre-configured SSB and CSI-RS configuration information through higher layer signaling (e.g., RRC message) and L1 signaling (e.g., DCI) for energy saving is disclosed. Pre-configured SSB and CSI-RS configuration information may be reconfigured for a terminal through higher layer signaling (e.g., RRC message) and L1 signaling (e.g., DCI) for energy saving from a BS, and the terminal may determine an RS resource according to whether a new RS resource for a PL-RS is configured, as in the following methods.

Method 5-2

A BS may reconfigure, for a terminal, pre-configured SSB and CSI-RS configuration information through higher layer signaling (e.g., RRC message) and L1 signaling (e.g., DCI) for energy saving, and may configure a new RS resource for a PL-RS therefor. The terminal does not apply a conventional method of determining a PL-RS and may apply a configured new RS resource to measure a DL path loss and determine SRS transmission power. As a method of configuring a new RS resource for a PL-RS, an SSB index and a CSI-RS index may be pre-configured through higher layer signaling (e.g., RRC message), or may be configured through L1 signaling (e.g., a DCI format for energy saving). Thereafter, the BS may perform beam management, based on the SSB index and CSI-RS index which are reconfigured according to an embodiment.

Method 5-3

A BS may reconfigure, for a terminal, pre-configured SSB and CSI-RS configuration information through higher layer signaling (e.g., RRC message) and L1 signaling (e.g., DCI) for energy saving, and may not configure a new RS resource for a PL-RS therefor. The terminal may determine a PL-RS as in the following methods according to whether there is a pre-configured RS resource for energy saving.

Method 5-4

When a BS reconfigures, for a terminal, pre-configured SSB and CSI-RS configuration information through higher layer signaling (e.g., RRC message) and L1 signaling (e.g., DCI) for energy saving, an RS resource having been used as a PL-RS may be canceled based on the reconfigured SSB and CSI-RS transmission information. If RS resources for energy saving are configured for the terminal in advance through higher layer signaling, the terminal may identify RS resource indexes overlapping or mapped between the RS resources configured for energy saving and pathlossReferenceRS or SRS-PathlossReferenceRS, which is previously configured, and may use the identified RS resource indexes as a PL-RS.

Method 5-5

When a BS reconfigures, for a terminal, pre-configured SSB and CSI-RS configuration information through higher layer signaling (e.g., RRC message) and L1 signaling (e.g., DCI) for energy saving, an RS resource having been used as a PL-RS may be canceled based on the reconfigured SSB and CSI-RS transmission information. If RS resources for energy saving are configured for the terminal in advance through higher layer signaling and there are no RS resource indexes overlapping or mapped between the RS resources configured for energy saving and pathlossReferenceRS or SRS-PathlossReferenceRS, which is previously configured, the terminal may determine, as a PL-RS, one of the RS resources configured in advance for energy saving or an RS resource having the lowest index.

Method 5-6

When a BS reconfigures, for a terminal, pre-configured SSB and CSI-RS configuration information through higher layer signaling (e.g., RRC message) and L1 signaling (e.g., DCI) for energy saving, an RS resource having been used as a PL-RS may be canceled based on the reconfigured SSB and CSI-RS transmission information. If RS resources for energy saving are not configured for the terminal in advance through higher layer signaling, the terminal may determine a PL-RS according to an RS resource having the lowest index among RS resources which have not been canceled among candidate RS resources previously configured according to pathlossReferenceRS or SRS-PathlossReferenceRS.

Method 5-7

When a BS reconfigures, for a terminal, pre-configured SSB and CSI-RS configuration information through higher layer signaling (e.g., RRC message) and L1 signaling (e.g., DCI) for energy saving, an RS resource having been used as a PL-RS may be canceled based on the reconfigured SSB and CSI-RS transmission information. When RS resources for energy saving are not configured for the terminal in advance through higher layer signaling and all RS resources previously configured for the terminal are canceled, the terminal may use, as a PL-RS, an SSB having been used to receive an MIB, or may continuously apply a DL path loss measured using an existing PL-RS until an operation is reconfigured from an operation for energy saving to a normal operation. If DL pathloss measurement is not performed for a predetermined period, the terminal may perform handover.

Through the above methods, when an RS resource used as a PL-RS is canceled by RS resource reconfiguration by a BS for energy saving, a terminal may determine an RS resource for a PL-RS of the terminal and determine power for SRS transmission. Configuration from a BS may be applied and limited to a mode for energy saving. When a BS changes or configures a mode from an energy saving mode to a normal mode, a terminal may recycle an existing configuration to determine a resource for a PL-RS. Through the above methods, a terminal may determine a PL-RS while a BS does not transmit RS resources or transmits reduced RS signals for energy saving.

Method 6-1

In method 6-1, limitations on a BS for cell operation when the BS changes, for a terminal, pre-configured SSB and CSI-RS configuration information through higher layer signaling (e.g., RRC message) and L1 signaling (e.g., DCI) for energy saving are disclosed. A BS may reconfigure a reference signal by considering limitations through one of the following methods or a combination thereof.

Method 6-2

A BS may determine a cancelable SSB to reduce the number of times of SSB transmission or cancel transmission and adjust a period. More specifically, a BS may cancel an SSB other than an SSB used by a terminal in initial access. Therefore, the terminal may not consider that an SSB used in initial access is canceled.

Method 6-3

A BS may determine a cancelable SSB to reduce the number of times of SSB transmission or cancel transmission and adjust a period. More specifically, in order to cancel an SSB, if there is a CSI-RS, the qcl-type of which is configured as TypeD, the SSB is replaceable with the CSI-RS, and thus the BS may cancel the SSB.

Method 6-4

A BS may determine a cancelable CSI-RS to reduce the number of times of CSI-RS transmission or cancel transmission and adjust a period. More specifically, in order to cancel a CSI-RS, if there is an SSB, the qcl-type of which is configured as TypeD, the CSI-RS is replaceable with the SSB, and thus the BS may cancel the CSI-RS. In addition, the BS may cancel only a CSI-RS having at least one port, which is used to measure L1-RSRP and L1-RSRQ for DL pathloss and beam management.

Based on the above methods, a BS may determine cancelable reference signals. The above methods may be used for a terminal to determine a reference signal that is not always canceled, and a minimum function for cell operation may be provided and complexity may be reduced. However, excessive energy may be consumed.

### Fourth Embodiment

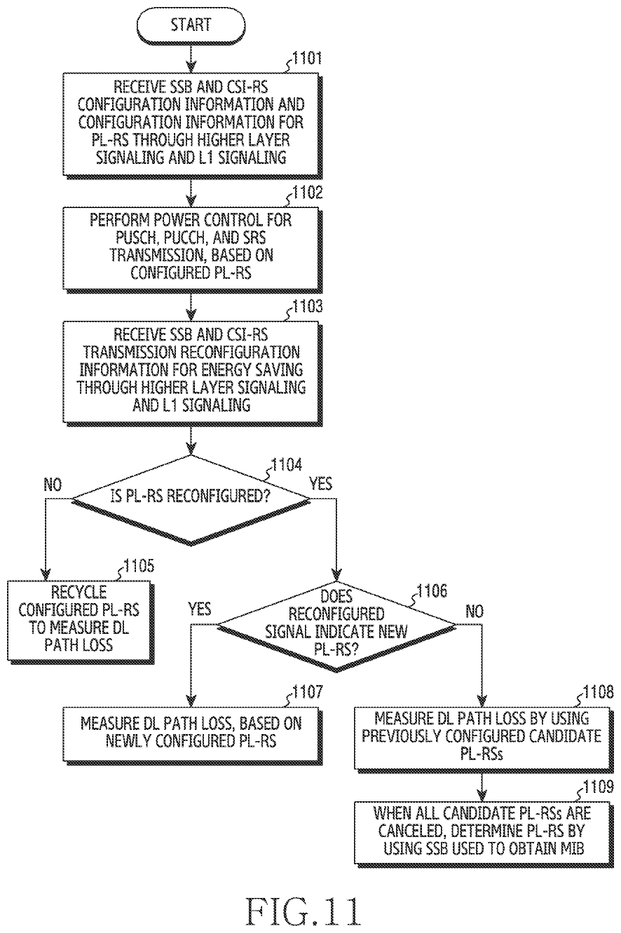

FIG. 11 is a flowchart for a terminal that determines an RS resource for a PL-RS according to reconfiguration of a reference signal for energy saving of a 5G system according to an embodiment of the disclosure.

In step 1101, a terminal may receive, from a BS, SSB CSI-RS configuration information and configuration information for a PL-RS through higher layer signaling (e.g., RRC message) and L1 signaling (e.g., DCI). In step 1102, the terminal may measure a DL path loss, based on a PL-RS determined through the SSB CSI-RS configuration information and the configuration information for the PL-RS received from the BS, and control UL (e.g., PUSCH, PUCCH, and/or SRS) transmission power. In step 1103, the terminal may receive reconfiguration information of a reference signal (e.g., SSB or CSI-RS) for energy saving through higher layer signaling (e.g., RRC message) and L1 signaling (e.g., DCI). In step 1104, the terminal may determine whether to reconfigure the PL-RS, based on the reconfigured configuration information. In step 1105, if the existing PL-RS is not canceled by the reconfigured reference signal configuration information, the terminal may use the existing PL-RS. In step 1106, if the PL-RS is canceled by the reconfigured reference signal configuration information, the terminal may determine a PL-RS according to whether a new RS resource is reconfigured from the reconfigured reference signal configuration information, for energy saving. In step 1107, if the terminal receives a new PL-RS from the BS through signaling for energy saving, the terminal may determine the configured RS resource as a PL-RS, and measure a DL path loss by using the determined PL-RS. In step 1108, if no information for a PL-RS is configured for the terminal by the BS through signaling for energy saving, the terminal may determine a PL-RS by using existing candidate RS resources. In step 1109, if RS resources for all candidate PL-RSs are canceled, the terminal may determine a PL-RS by using an SSB used to obtain an MIB and measure a DL path loss. If it is possible that methods of determining a PL-RS are branched according to reconfiguration information received from the BS, the sequence of the flowchart may be changed or combined. In relation to the number of cases of a PL-RS determination method, methods described in the first embodiment, the second embodiment, and the third embodiment described above may be applied.

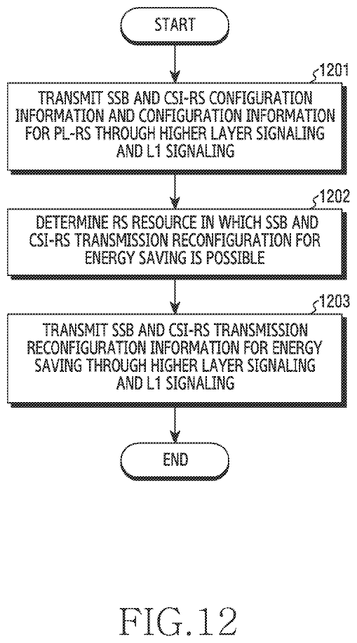

FIG. 12 is a flowchart of an operation of reconfiguring a reference signal for energy saving of a 5G system according to an embodiment of the disclosure.

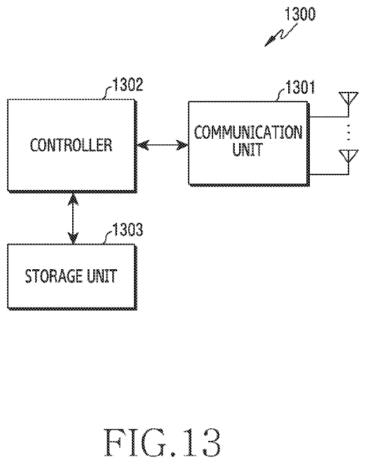

Referring to FIG. 12, in step 1201, a BS may transmit, to a terminal, SSB and CSI-RS configuration information and configuration information for a PL-RS through higher layer signaling (e.g., RRC message) and L1 signaling (e.g., DCI). Thereafter, in step 1202, the BS may determine a reference signal (e.g., SSB or CSI-RS), the transmission of which is cancelable, for energy saving. A method of determining whether a reference signal is cancelable may be determined as previously described. In step 1203, the BS may transmit, to the terminal, SSB and CSI-RS reconfiguration information for energy saving through higher layer signaling (e.g., RRC message) and L1 signaling (e.g., DCI) FIG. 13 is a block diagram of a terminal according to an embodiment.

Referring to FIG. 13, a terminal 1300 may include a communication unit 1301, a controller (e.g., a processor) 1302, and a storage unit (e.g., a memory) 1303. According to at least one of the above methods, the communication unit 1301, the controller 1302, and the storage unit 1303 of the terminal 1300 may operate. However, the elements of the terminal 1300 are not limited to the illustrated example, and the terminal 1300 may also include a different number of elements than the above elements. In addition, in a particular case, the communication unit 1301, the controller 1302, and the storage unit 1303 may be implemented in a single chip type.

The communication unit 1301 may also be configured by a transmitter and a receiver according to an embodiment. The communication unit 1301 may transmit or receive signals to or from a BS. The signal may include control information and data. The communication unit 1301 may include an RF transmitter that up-converts and amplifies a frequency of a transmitted signal, and an RF receiver that low-noise amplifies a received signal and down-converts the frequency. The communication unit 1301 may receive a signal through a wireless channel and output the signal to the controller 1302, and may transmit a signal output from the controller 1302, through a wireless channel.

The controller 1302 may control a series of procedures, in which the terminal 1300 is operable, according to an embodiment of the disclosure described above. For example, the controller 1302 may perform or control an operation of the terminal for performing at least one of methods according to embodiments of the disclosure or a combination thereof. The controller 1302 may include at least one processor, a communication processor (CP) performing control for communication, and an application processor (AP) controlling a higher layer (e.g., an application).

The storage unit 1303 may store control information (e.g., information related to channel estimation using DMRSs transmitted through a PUSCH included in a signal obtained by the terminal 1300) or data, and may have a region for storing data required for control of the controller 1302, and data generated by control by the controller 1302.

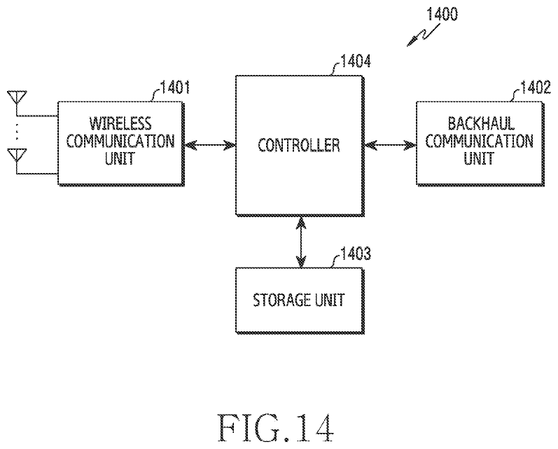

FIG. 14 is a block diagram of a BS according to an embodiment.

Referring to FIG. 14, a BS 1400 may include a communication unit (e.g., a wireless communication unit) 1401, a backhaul communication unit 1402, a storage unit (e.g., a memory) 1403, and a controller (e.g., a processor) 1404. According to at least one of methods corresponding to the above embodiments or a combination thereof, the communication unit 1401, the backhaul communication unit 1402, the storage unit 1403, and the controller 1404 of the BS 1400 may operate. However, the elements of the BS 1400 are not limited to the illustrated example. According to another embodiment, the BS 1400 may also include more or fewer elements than the above elements. In addition, in a particular case, the communication unit 1401, the controller 1404, and the storage unit 1403 may be implemented in a single chip type.

The communication unit 1401 may also be configured by a transmitter and a receiver according to an embodiment. The communication unit 1401 may transmit or receive signals to or from a terminal. The signal may include control information and data. The communication unit 1401 may include an RF transmitter that up-converts and amplifies a frequency of a transmitted signal, and an RF receiver that low-noise amplifies a received signal and down-converts the frequency. The communication unit 1401 may receive a signal through a wireless channel and output the signal to the controller 1404, and may transmit a signal output from the controller 1404, through a wireless channel.

The backhaul communication unit 1402 provides an interface for performing communication with other nodes within a network. That is, the backhaul communication unit 1402 converts, into a physical signal, a bitstream transmitted from the BS to another node another access node, another BS, a higher node, a core network, etc., and converts a physical signal received from another node into a bitstream.

The storage unit 1403 may store control information (e.g., information related to channel estimation generated using DMRSs transmitted through a PUSCH determined by the BS 1400) or data, or control information or data received from a terminal, and may have a region for storing data required for control of the controller 1404, and data generated by control by the controller 1404. The controller 1404 may control a series of procedures so that the BS 1400 is operable according to an embodiment of the disclosure described above. For example, the controller 1404 may perform or control an operation of the BS for performing at least one of methods according to embodiments of the disclosure or a combination thereof. The controller 1404 may include at least one processor, a communication processor (CP) performing control for communication, and an application processor (AP) controlling a higher layer (e.g., an application).

The methods according to the embodiments described in the claims or the specification of the disclosure may be implemented in software, hardware, or a combination of hardware and software.

As for the software, a computer-readable storage medium storing one or more programs (software modules) may be provided. One or more programs stored in the computer-readable storage medium may be configured for execution by one or more processors of an electronic device. One or more programs may include instructions for controlling an electronic device to execute the methods of the disclosure.

Such a program (software module, software) may be stored to a random access memory, a non-volatile memory including a flash memory, a read only memory (ROM), an electrically erasable programmable ROM (EEPROM), a magnetic disc storage device, a compact disc (CD)-ROM, a digital versatile disc (DVD) or other optical storage device, and a magnetic cassette. Alternatively, it may be stored to a memory combining part or all of those recording media. A plurality of memories may be included.

The program may be stored in an attachable storage device accessible via a communication network such as internet, intranet, local area network (LAN), wide LAN (WLAN), or storage area network (SAN), or a communication network by combining these networks. Such a storage device may access a device which executes an embodiment of the disclosure through an external port. A separate storage device on the communication network may access the device which executes an embodiment of the disclosure.

Herein, each block of the flowchart illustrations, and combinations of blocks in the flowchart illustrations, can be implemented by computer program instructions provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Each block of the flowchart illustrations may represent a module, segment, or portion of code, which includes one or more executable instructions for implementing the specified logical function(s). In some alternative implementations, the functions noted in the blocks may occur out of the order. For example, two blocks shown in succession may in fact be executed substantially concurrently or the blocks may sometimes be executed in the reverse order, depending upon the functionality involved.

A part of one embodiment of the disclosure may be combined with a part of another embodiment to operate a BS and a terminal. Although the above embodiments have been presented based on the frequency division duplex (FDD) LTE system, other variants based on the technical idea of the above embodiments may also be implemented in other systems such as time division duplex (TDD) LTE, 5G, or NR systems.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A method performed by a user equipment (UE) in a wireless communication system, the method comprising:
receiving, from a base station, configuration information associated with at least one first reference signal (RS);
receiving, from the base station, reconfiguration information associated with at least one second RS; and
identifying a pathloss-RS (PL-RS) for measuring a downlink pathloss based on the configuration information and the reconfiguration information,
wherein a first transmission density of the at least one first RS is greater than a second transmission density of the at least one second RS.

2. The method of claim 1,
wherein the PL-RS is identified based on whether at least two transmission resources of the at least one first RS and the at least one second RS overlap, and
wherein, in case that the at least two transmission resources do not overlap, the downlink pathloss is measured based on the at least one first RS.

3. The method of claim 2,
wherein, in case that a portion of the at least two transmission resources overlap, the downlink pathloss is measured based on an RS corresponding to non-overlapping transmission.

4. The method of claim 2,
wherein, in case that the at least two transmission resources fully overlap, the downlink pathloss is measured based on a synchronization signal block (SSB) for an initial access.

5. The method of claim 1,
wherein each of the at least one first RS and the at least one second RS is at least one of a SSB or a channel status information-reference signal (CSI-RS).

6. A method performed by a base station in a wireless communication system, the method comprising:
transmitting, to a user equipment (UE), configuration information associated with at least one first reference signal (RS); and
transmitting, to the UE, reconfiguration information associated with at least one second RS,
wherein a pathloss-RS (PL-RS) for measuring a downlink pathloss is identified based on the configuration information and the reconfiguration information, and
wherein a first transmission density of the at least one first RS is greater than a second transmission density of the at least one second RS.

7. The method of claim 6,
wherein the PL-RS is identified based on whether at least two transmission resources of the at least one first RS and the at least one second RS overlap, and
wherein, in case that the at least two transmission resources do not overlap, the downlink pathloss is measured based on the at least one first RS.

8. The method of claim 7,
wherein, in case that a portion of the at least two transmission resources overlap, the downlink pathloss is measured based on an RS corresponding to non-overlapping transmission.

9. The method of claim 7,
wherein, in case that the at least two transmission resources fully overlap, the downlink pathloss is measured based on a synchronization signal block (SSB) for an initial access.

10. The method of claim 6,
wherein each of the at least one first RS and the at least one second RS is at least one of a SSB or a channel status information-reference signal (CSI-RS).

11. A user equipment (UE) in a wireless communication system, the UE comprising:
a transceiver; and
at least one processor coupled with the transceiver and configured to:
receive, from a base station, configuration information associated with at least one first reference signal (RS),
receive, from the base station, reconfiguration information associated with at least one second RS, and
identify a pathloss-RS (PL-RS) for measuring a downlink pathloss based on the configuration information and the reconfiguration information,
wherein a first transmission density of the at least one first RS is greater than a second transmission density of the at least one second RS.

12. The UE of claim 11,
wherein the PL-RS is identified based on whether at least two transmission resources of the at least one first RS and the at least one second RS overlap, and
wherein, in case that the at least two transmission resources do not overlap, the downlink pathloss is measured based on the at least one first RS.

13. The UE of claim 12,
wherein, in case that a portion of the at least two transmission resources overlap, the downlink pathloss is measured based on an RS corresponding to non-overlapping transmission.

14. The UE of claim 12,
wherein, in case that the at least two transmission resources fully overlap, the downlink pathloss is measured based on a synchronization signal block (SSB) for an initial access.

15. The UE of claim 11,
wherein each of the at least one first RS and the at least one second RS is at least one of a SSB or a channel status information-reference signal (CSI-RS).

16. Abase station in a wireless communication system, the base station comprising:
a transceiver; and
at least one processor coupled with the transceiver and configured to:
transmit, to a user equipment (UE), configuration information associated with at least one first reference signal (RS), and
transmit, to the UE, reconfiguration information associated with at least one second RS,
wherein a pathloss-RS (PL-RS) for measuring a downlink pathloss is identified based on the configuration information and the reconfiguration information, and
wherein a first transmission density of the at least one first RS is greater than a second transmission density of the at least one second RS.

17. The base station of claim 16,
wherein the PL-RS is identified based on whether at least two transmission resources of the at least one first RS and the at least one second RS overlap, and
wherein, in case that the at least two transmission resources do not overlap, the downlink pathloss is measured based on the at least one first RS.

18. The base station of claim 17,
wherein, in case that a portion of the at least two transmission resources overlap, the downlink pathloss is measured based on an RS corresponding to non-overlapping transmission.

19. The base station of claim 17,
wherein, in case that the at least two transmission resources fully overlap, the downlink pathloss is measured based on a synchronization signal block (SSB) for an initial access.

20. The base station of claim 16,
wherein each of the at least one first RS and the at least one second RS is at least one of a SSB or a channel status information-reference signal (CSI-RS).
